(19) United States
(12) Patent Application Publication
(10) Pub. No.: US 2016/0341848 A1
(43) Pub. Date: Nov. 24, 2016

(54) OBJECT DETECTION APPARATUS, OBJECT REMOVEMENT CONTROL SYSTEM, OBJECT DETECTION METHOD, AND STORAGE MEDIUM STORING OBJECT DETECTION PROGRAM

(71) Applicant: Satoshi NAKAMURA, Kanagawa (JP)

(72) Inventor: Satoshi NAKAMURA, Kanagawa (JP)

(21) Appl. No.: 15/149,393

(22) Filed: May 9, 2016

(30) Foreign Application Priority Data
May 22, 2015 (JP) 2015-104621
Mar. 15, 2016 (JP) 2016-051069

(51) Int. Cl. G01V 8/00; B60S 1/08

(52) U.S. Cl. CPC G01V 8/00; B60S 1/0844

(57) ABSTRACT

An object detection apparatus includes a light source to emit detection-use light, a light receiver to receive first light having lighting-period received light quantity used for detecting a detection-target object existing within a lighting area of the detection-use light when the light source emits the detection-use light, and second light having non-lighting-period received light quantity when the light source does not emit the detection-use light, and a detection processor to perform a detection process to determine whether a given condition used for detecting an increase or decrease of the detection-target object within the lighting area is satisfied based on lighting-period changed quantity indicating a change of the lighting-period received light quantity over the time, and non-lighting-period changed quantity indicating a change of the non-lighting-period received light quantity over the time.

### CROSS-REFERENCE TO RELATED APPLICATIONS

This patent application is based on and claims priority pursuant to 35 U.S.C. §119(a) to Japanese Patent Application Nos. 2015-104621, filed on May 22, 2015, and 2016-051069, filed on Mar. 15, 2016 in the Japan Patent Office, the entire disclosure of which is incorporated by reference herein.

### BACKGROUND

Technical Field

The present disclosure relates to an object detection apparatus, an object removement control system, an object detection method, and a storage medium storing object detection program.

Description of the Related Art

Object detection apparatuses that can detect detection-target objects such as raindrops are known. The object detection apparatus includes a light source that emits detection-use light to light a detection-target object (e.g., raindrops) within a lighting area, and a light receiver such as an image sensor to receive light reflected from the detection-target object and generate an image of detection-target object for detecting the detection-target object.

For example, the object detection apparatus is applied as a raindrop detection apparatus that can detect raindrops adhering on a windshield of an automobile, in which the windshield is an example of optical transparency material. Specifically, when the detection-use light emitted from the light source is reflected from the windshield, reflection light is received by a raindrop detection image area of the image sensor to generate an image of raindrop, with which raindrops adhering on the windshield can be detected.

The raindrop detection apparatus performs a raindrop detection process based on differential information of a light-ON image that is captured when the light source emits the detection-use light and a light-OFF image that is captured when the light source does not emit the detection-use light to reduce an effect of ambient light, which is not the detection-use light, that degrades the precision of the raindrop detection. When the raindrop is detected by performing the raindrop detection process, a wiper is activated. Since the light-OFF image is an image generated only by the ambient light, the differential information obtained by subtracting the light-OFF image from the light-ON image corresponds to information that an ambient-light-related component is removed from the light-ON image. By performing the raindrop detection process based on the differential information, the raindrop detection process that reduces the effect of ambient light can be performed.

However, when the raindrop detection process is performed based on the differential information while the ambient light changes greatly within a short time, the ambient-light-related component included in the light-ON image and the ambient-light-related component included in the light-OFF image become different. In this case, the differential information does not become information that removes the ambient-light-related component from the light-ON image correctly, with which a detection error may occur during the raindrop detection process. The detection error may mean that raindrops are detected although the raindrops do not actually adhere on the windshield, or raindrops are not detected but the raindrops actually adheres on the windshield.

Therefore, the raindrop detection apparatus calculates a differential value of two light-OFF images, which are captured before and after one light-ON image, and determines whether the differential value of the two light-OFF images exceeds a threshold. If it is determined that the differential value of the two light-OFF image exceeds the threshold, it is determined that the ambient light changes greatly within a short time, and then the raindrop detection apparatus stops the raindrop detection process based on the differential information.

When the raindrop detection process is performed based on the differential information of the light-ON image and the light-OFF image alone, the detection error may occur if components other than the ambient light that may change the luminance value exists. The components other than the ambient light may be caused by a change of light quantity of the detection-use light caused by the temperature change and aging, a change of optical properties of optical parts disposed along a light path, and fogging and stain on the windshield. For example, one raindrop detection process can detect that raindrops adhere on the windshield if the total luminance value of differential image becomes a given threshold or more. However, if components other than the ambient light that may change the luminance value exists, the total luminance value of differential image may change even if the raindrop adhesion condition is the same, and the detection error may occur.

### BRIEF SUMMARY

As one aspect of the disclosure, an object detection apparatus includes a light source to emit detection-use light, a light receiver to receive first light having lighting-period received light quantity used for detecting a detection-target object existing within a lighting area of the detection-use light when the light source emits the detection-use light, and second light having non-lighting-period received light quantity when the light source does not emit the detection-use light, and a detection processor to perform a detection process to determine whether a given condition used for detecting an increase or decrease of the detection-target object within the lighting area is satisfied based on lighting-period changed quantity indicating a change of the lighting-period received light quantity over the time, and non-lighting-period changed quantity indicating a change of the non-lighting-period received light quantity over the time.

As another aspect of the disclosure, a method of detecting an object includes emitting detection-use light from a light source, receiving first light having lighting-period received light quantity used for detecting a detection-target object existing within a lighting area of the detection-use light when the light source emits the detection-use light, and second light having non-lighting-period received light quantity when the light source does not emit the detection-use light, and performing a detection process to determine whether a given condition used for detecting an increase or decrease of the detection-target object within the lighting area is satisfied based on lighting-period changed quantity indicating a change of the lighting-period received light quantity over the time, and non-lighting-period changed quantity indicating a change of the non-lighting-period received light quantity over the time.

As another aspect of the disclosure, a non-transitory storage medium storing a program that, when executed by a computer, causes the computer to execute a method of detecting an object includes emitting detection-use light from a light source, receiving first light having lighting-period received light quantity used for detecting a detection-target object existing within a lighting area of the detection-use light when the light source emits the detection-use light, and second light having non-lighting-period received light quantity when the light source does not emit the detection-use light, and performing a detection process to determine whether a given condition used for detecting an increase or decrease of the detection-target object within the lighting area is satisfied based on lighting-period changed quantity indicating a change of the lighting-period received light quantity over the time, and non-lighting-period changed quantity indicating a change of the non-lighting-period received light quantity over the time.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1A illustrates a schematic configuration of a control system that controls vehicle-installed devices according to a first example embodiment;

FIG. 1B illustrates an example of hardware configuration of an image analyzer;

FIG. 2 illustrates a schematic configuration of an image capture device and the image analyzer of the control system;

FIG. 3 illustrates an example of an optical system of an image capturing unit;

FIG. 4 illustrates a perspective view of a schematic configuration of the image capturing unit;

FIG. 5A illustrates a side view of the image capturing unit attached to a windshield of a vehicle having an inclination angle of 22 degrees with respect to the horizontal direction;

FIG. 5B illustrates an optical scheme of the image capturing unit when raindrops do not adhere under the condition illustrated in FIG. 5A;

FIG. 5C illustrates an optical scheme of the image capturing unit when raindrops adhere under the condition illustrated in FIG. 5A;

FIG. 6 illustrates a perspective view of a reflective deflection prism of the image capturing unit;

FIG. 7 is a graph of a filter property of a cut-filter applicable for image data captured for detecting raindrops;

FIG. 8 is a graph of a filter property of a band-pass filter applicable for image data captured for detecting raindrops;

FIG. 9 illustrates a front view of a front-end filter disposed for an optical filter;

FIG. 10 illustrates an example of image generated from captured image data;

FIG. 11 illustrates a schematic configuration of the optical filter and an image sensor viewed from a direction perpendicular to a light passing direction.

FIG. 12 illustrates an area segmentation pattern of a polarized-light filter and a light-separation filter of the optical filter;

FIG. 13 is a schematic view of a vehicle detection image area and a raindrop detection image area used for a raindrop detection process of the first example embodiment.

FIG. 14 is a scheme of a relationship of image capturing frames and the raindrop detection of the first example embodiment;

FIG. 15 is a flowchart illustrating the steps of a raindrop detection process of the first example embodiment;

FIG. 16 is a flowchart illustrating the steps of a raindrop detection process of the variant example 1 of the first example embodiment;

FIG. 17 is a flowchart illustrating the steps of a threshold changing process of the variant example 1 of the first example embodiment;

FIG. 18 is a flowchart illustrating the steps of a raindrop detection process of the variant example 2 of the first example embodiment;

FIG. 19 is a flowchart illustrating the steps of another raindrop detection process of the variant example 2; and

FIG. 20 illustrates various light used for a raindrop detection process according to a second example embodiment.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION OF EMBODIMENTS

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

### First Example Embodiment

A description is given of an object detector or object detection apparatus according to a first example embodiment of this description. For example, the object detector or object detection apparatus can be used as an adhered substance detection apparatus for a control system to control vehicle-installed devices, which controls the devices installed in a vehicle such as an automobile. Further, the object detector or object detection apparatus according to the first example embodiment can be applied for other systems, which performs various processing and controlling based on detection results of detection-target objects. The object detector or object detection apparatus according to the first example embodiment can be applied to various control systems for controlling devices installed in moveable vehicles such as automobiles, ships, airplanes, robots or the like. Further, the object detector or object detection apparatus according to the first example embodiment can be applied to various control systems for controlling processing by processing machines such as machines of factory automation (FA), which may not be installed in movable vehicles.

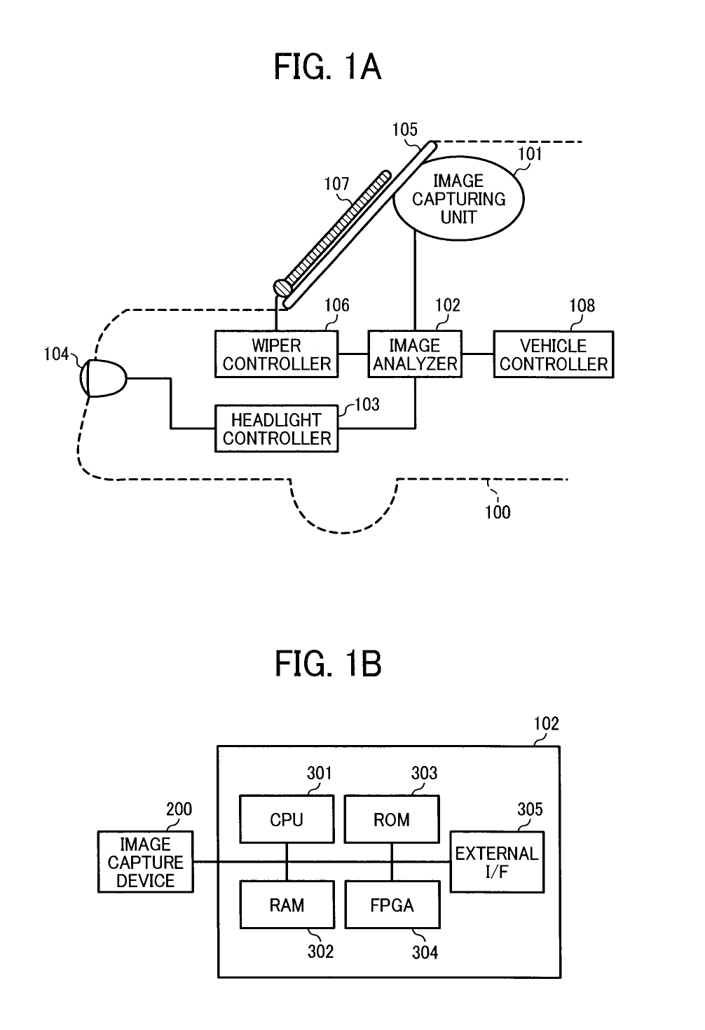

FIG. 1A illustrates a schematic configuration of a control system that controls vehicle-installed devices according to a first example embodiment, which may be referred to as a vehicle-installed device control system. A vehicle 100 such as automobiles may include a control system that controls the vehicle-installed devices, and an image capturing device. The image capturing device can capture images of areas around the vehicle 100 such as a front area of the vehicle 100 as captured image data. Based on the captured image data, the control system to control vehicle-installed devices can conduct a light control of headlight, a wiper-drive control, a control of defroster, a control of other vehicle-installed devices, or the like.

The image capturing device used for the control system to control the vehicle-installed devices is disposed in an image capturing unit 101. The image capturing device captures views of vehicle-front-area of the vehicle 100, wherein the vehicle-front-area may be referred to as image capturing area or captured image area. For example, the image capturing device captures a vehicle-front-area of the vehicle 100 when the vehicle 100 is running. The image capturing device may be, for example, disposed near a rear-view mirror and a windshield 105 of the vehicle 100. Image data captured by the image capturing device of the image capturing unit 101 is input to the image analyzer 102. The image analyzer 102, which may be composed of a central processing unit (CPU), a random access memory (RAM) or the like, analyzes the captured image data, transmitted from the image capturing device, in which the image analyzer 102 can be used to compute information of other vehicles existing in a front direction of the vehicle 100 such as vehicle position, a point of the compass (e.g., north, south, east, west), and distance to other vehicles. Further, the image analyzer 102 can be used to detect substance adhered on the windshield 105 such as raindrops, foreign particles, or the like. Further, the image analyzer 102 can be used to detect a detection-target object existing on road surfaces such as a lane (e.g., white line) or the like from the image capturing area. Further, the image analyzer 102 can be used to detect other vehicles. Specifically, by recognizing a tail lamp of other vehicles, the image analyzer 102 can detect a front-running vehicle (ahead vehicle) running in front of the vehicle 100 in the same running direction, and by recognizing a headlight of other vehicles, the image analyzer 102 can detect an incoming vehicle coming toward the vehicle 100 such as head-to-head direction. The image analyzer 102 can be configured with any hardware configurations that can devise the above described capabilities. FIG. 1B illustrates an example of hardware configuration of the image analyzer 102. The image analyzer 102 includes, for example, a central processing unit (CPU) 301, a random access memory (RAM) 302, a read only memory (ROM) 303, a field-programmable gate array (FPGA) 304, and an external interface (I/F) 305. The CPU 301 reads and executes programs. The RAM 302 and the ROM 303 stores data such as programs. The FPGA 304 preforms processing based on input signals. The external I/F 305 is used for outputting output signals of the CPU 301 and FPGA 304 outside. The image analyzer 102 can devise various capabilities such as a detection processor 102A, a light source controller 102B, and an exposure controller 102C by using these hardware devices.

The computation result of the image analyzer 102 can be transmitted to the headlight controller 103. For example, the headlight controller 103 generates control signals to control a headlight 104 from distance data computed by the image analyzer 102. The headlight 104 is one of devices installed in the vehicle 100. Specifically, for example, a switching control of high beam/low beam of the headlight 104 is conducted, and a light-dimming control is partially conducted for the headlight 104 to prevent a projection of high intensity light of headlight of the vehicle 100 to eyes of drivers of front-running vehicles (ahead vehicles) and incoming vehicles. Therefore, the drivers of other vehicles are not dazzled by light coming from the headlight of the vehicle 100 while providing the sufficient field of view for the driver of vehicle 100.

The computation result of the image analyzer 102 is also transmitted to the wiper controller 106. The wiper controller 106 controls a wiper 107 to remove substance (detection-target object) adhered on the windshield 105 such as raindrops, foreign particles, or the like from the windshield 105 of the vehicle 100. The wiper 107 is used as a removing unit. The wiper controller 106 generates control signals to control the wiper 107 upon receiving the detection result of substances from the image analyzer 102. When the control signals generated by the wiper controller 106 are transmitted to the wiper 107, the wiper 107 is activated to provide the field of view for the driver of the vehicle 100.

Further, the computation result of the image analyzer 102 is also transmitted to a vehicle controller 108, which controls the driving of the vehicle 100. If the vehicle 100 deviates or departs from the vehicle lane, defined by the lane (e.g., white line), based on the detection result of the lane detected by the image analyzer 102, the vehicle controller 108 activates an alarm or warning to the driver of the vehicle 100, and activates a cruise control system such as controlling of a steering wheel and/or brake of the vehicle 100. Further, the vehicle controller 108 activates an alarm or warning to the driver of the vehicle 100 and activates a cruise control system such as controlling of a steering wheel and/or brake of the vehicle 100 if the detected distance to an ahead vehicle is too close based on position data of the ahead vehicle detected by the image analyzer 102.

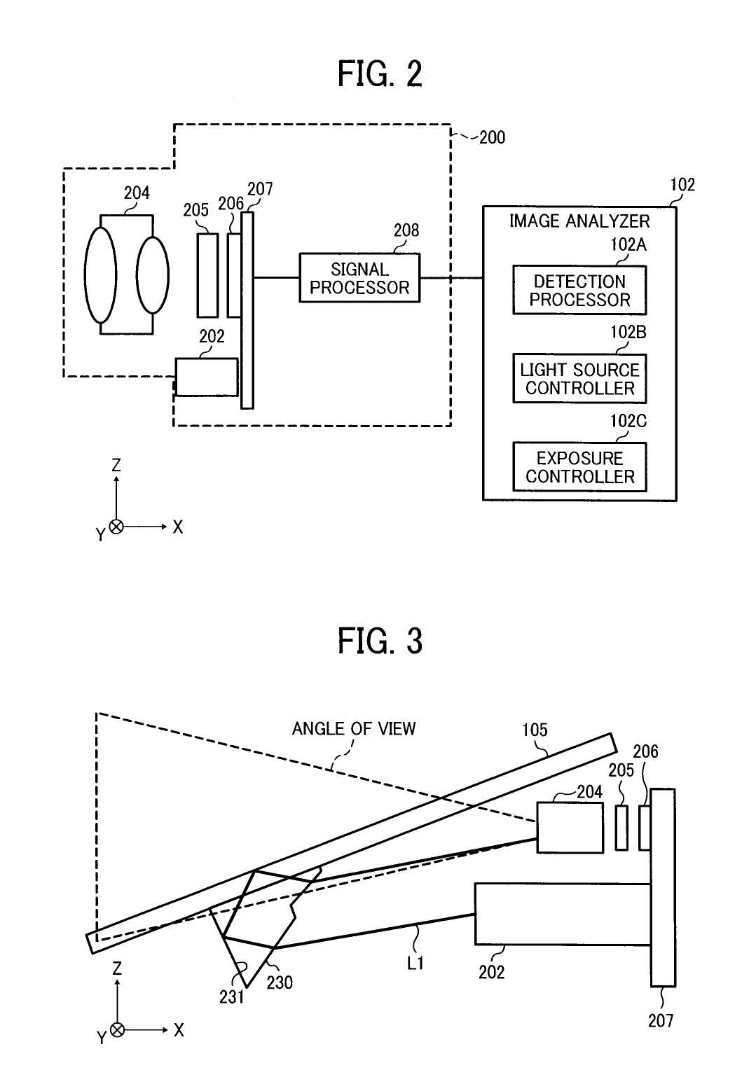

FIG. 2 illustrates a schematic configuration of the image capture device 200 disposed in the image capturing unit 101 and the image analyzer 102 used as an adhered substance detection apparatus. As illustrated in FIG. 2, the image capture device 200 includes, for example, a capture lens 204, an optical filter 205, a sensor board 207, and a signal processor 208. The sensor board 207 includes an image sensor 206 composed of a two-dimensional pixel array, which can be configured by arraying a number of light receiving elements in two dimensional directions. Each of light receiving elements of the image sensor 206 receives light having a given quantity, and the sensor board 207 outputs analog electrical signals corresponding to the received light quantity to the signal processor 208. Upon receiving the analog electrical signals, the signal processor 208 converts the analog electrical signals to digital electrical signals to generate and output the captured image data. Further, a light source unit 202 is disposed on the sensor board 207 as a light source. The light source unit 202 is disposed at an inner face (one face or first face) side of the windshield 105, and the light source unit 202 can be used to detect substance adhered on an outer face (other face or second face) of the windshield 105, wherein the adhered substance (i.e., detection-target object) is, for example, raindrops. The windshield 105 is an example of optical transparency material. The light source unit 202 can emit detection-use light.

In the first example embodiment, the optical axis of the capture lens 204 is disposed in the image capturing unit 101 by aligning the optical axis of the capture lens 204 to the horizontal direction, but not limited hereto. For example, the optical axis of the capture lens 204 can be set to a given direction with respect to the horizontal direction (X direction in FIG. 2). The capture lens 204 can be configured with, for example, a plurality of lenses, and has a focal position set at a position far from the windshield 105. The focal position of the capture lens 204 can be set, for example, at infinity or between infinity and the windshield 105.

The image sensor 206 is composed of a plurality of light receiving elements arranged two-dimensionally to receive light passing through the optical filter 205, and each light receiving elements (or image capturing pixel) has a function of photoelectric conversion of incident light. The image sensor 206 includes a cover glass to protect the light receiving elements. For example, the image sensor 206 is composed of about several hundreds of thousands of pixels arranged two-dimensionally. The image sensor 206 employs, for example, a charge coupled device (CCD) that reads signals of each of image capturing pixels exposed at the same time (i.e., global shutter), and a complementary metal oxide semiconductor (CMOS) that reads signals of each of image capturing pixels exposed line by line (i.e., rolling shutter), and the light receiving elements may employ photodiodes.

Light coming from the image capturing area, including an object (or detection-target object), passes the capture lens 204 and the optical filter 205, and then the image sensor 206 photo-electrically converts the received light to electrical signals based on the light quantity. When the signal processor 208 receives electrical signals such as analog signals (i.e., quantity of incident light to each of light receiving elements of the image sensor 206) output from the sensor board 207, the signal processor 208 converts the analog signals to digital signal to be used as captured image data. The signal processor 208 is electrically connected with the image analyzer 102. Upon receiving the electrical signals (analog signals) from the image sensor 206 via the sensor board 207, the signal processor 208 generates the digital signals (captured image data) based on the received electrical signals, indicating luminance data for each of image capturing pixel of the image sensor 206. The signal processor 208 outputs the captured image data to a later stage unit such as the image analyzer 102 with horizontal/vertical synchronization signals of image.

Further, the image analyzer 102 can control the image capturing operation of the image capturing unit 101, and analyze captured image data transmitted from the image capturing unit 101. As to the image analyzer 102, an exposure controller 102C used as an exposure quantity controller can calculate a preferable exposure quantity for each of capturing targets (e.g., objects such as other vehicles ahead of the vehicle 100) of the image sensor 206 based on the captured image data transmitted from the image capturing unit 101, and can set a preferable exposure quantity to each of the capturing targets of the image sensor 206 (e.g., exposure time for the first example embodiment) Further, as to the image analyzer 102, a light source controller 102B used as a light source controller can control the emission timing of the light source unit 202 by linking with acquiring of image signals from the signal processor 208. Further, the image analyzer 102 can detect information such as road surface condition, road traffic signs, or the like based on the captured image data transmitted from the image capturing unit 101. Further, the image analyzer 102 can calculate information of other vehicles existing in a front direction of the vehicle 100 such as vehicle position, a point of the compass (e.g., north, south, east, west), and distance to other vehicles based on the captured image data transmitted from the image capturing unit 101.

Further, the image analyzer 102 can include a detection processor 102A. The detection processor 102A of the image analyzer 102 can be used to detect conditions of the windshield 105 (e.g., adhesion of raindrops, freezing, fogging). The detection processor 102A can detect the raindrop adhesion based on the captured image data transmitted from the image capturing unit 101, and calculate the raindrop amount on the windshield 105 based on the luminance value (i.e., pixel values) of the captured image data.

FIG. 3 illustrates an example of an optical system of the image capturing unit 101. The light source unit 202 irradiates light to detect substances adhered on the windshield 105 (e.g., raindrops, freezing, fogging). The light source unit 202 includes a plurality of light emitting elements such as light emitting diodes (LED). The light emitted from each of the LEDs can be output outside via an optical system such as a collimator lens. By disposing the plurality of light emitting elements such as LEDs, a detection area of substance adhering on the windshield 105 can be enlarged, and detection precision of substance adhering on the windshield 105 can be enhanced compared to using one light emitting element.

In the first example embodiment, the LEDs and the image sensor 206 are installed on the same sensor board 207, by which the numbers of board can be reduced compared to installing the LEDs and the image sensor 206 on different boards, by which less expensive cost can be achieved. Further, the LEDs can be arranged one row or a plurality of rows along the Y direction in FIG. 3. With this arrangement, the light used for capturing an image on the windshield 105, which is below an image area for displaying an image captured for a front direction of the vehicle 100, can be set as uniform light. As described above, the light source unit 202 and the image sensor 206 are installed on the same sensor board 207, but the light source unit 202 and the image sensor 206 can be installed on different boards.

The light source unit 202 is disposed on the sensor board 207 to set a given angle between the optical axis direction of the light emitted from the light source unit 202 and the optical axis direction of the capture lens 204. Further, the light source unit 202 is disposed at a position to set a lighting area on the windshield 105 lighted by the light emitted from the light source unit 202 is corresponded to a range of field angle (or a range of viewing angle) of the capture lens 204. The emission wavelength of the light source unit 202 is preferably light other than the visible light so that drivers of oncoming vehicles and foot passengers are not dazzled. For example, light that has a wavelength window longer than a wavelength window of the visible light and can be sensed by the image sensor 206 is used. For example, infrared light having the wavelength window of 800 nm to 1000 nm can be used. The drive control of the light source unit 202 such as emission timing control may be conducted by using the light source controller 102B of the image analyzer 102 while linked with obtaining of image signals from the signal processor 208.

As illustrated in FIG. 3, the image capturing unit 101 includes an optical member such as a reflective deflection prism 230 having a reflection face 231. The light emitted from the light source unit 202 can be reflected at the reflection face 231 and then guided to the windshield 105. The reflective deflection prism 230 has one face attached firmly to the inner face of the windshield 105 so that the light emitted from the light source unit 202 is guided to the windshield 105. Specifically, the regular reflection reflected regularly on the reflection face 231 of the reflective deflection prism 230 is guided to the windshield 105. The reflective deflection prism 230 is attached to the inner face (first face) of the windshield 105 with a condition to maintain that a regular reflection light reflected regularly at a non-adhering area, where the detection-target object such as raindrop does not adhere, on the outer face of the windshield 105, can be received by the image sensor 206 even when the incident angle of the light of the light source unit 202 entering the reflective deflection prism 230 changes within a given range.

When attaching the reflective deflection prism 230 to the inner face of the windshield 105, filler (i.e., light transmittable material) such as gel, sealing material, or the like is interposed between the reflective deflection prism 230 and the inner face of the windshield 105 to increase contact level. With this configuration, an air layer or bubble may not occur between the reflective deflection prism 230 and the windshield 105, by which the fogging may not occur between the reflective deflection prism 230 and the windshield 105. Further, the refractive index of filler is preferably between the refractive indexes of the reflective deflection prism 230 and the windshield 105 to reduce Fresnel reflection loss between the filler and the reflective deflection prism 230, and the filler and the windshield 105. The Fresnel reflection is a reflection that occurs between materials having different refractive indexes.

As illustrated in FIG. 3, the reflective deflection prism 230 regularly reflects an incident light from the light source unit 202 for one time at the reflection face 231 to direct the reflection light to the inner face of the windshield 105. The reflection light can be configured to have an incidence angle θ (e.g., θ≧about 42 degrees) with respect to the outer face of the windshield 105. This effective incidence angle θ is a critical angle that causes a total reflection on the outer face of the windshield 105 based on a difference of refractive indexes between air and the outer face of the windshield 105. Therefore, when substances such as raindrops do not adhere on the outer face of the windshield 105, the reflection light reflected at the reflection face 231 of the reflective deflection prism 230 does not pass through the outer face of the windshield 105 but totally reflected at the outer face of the windshield 105.

By contrast, when substances such as raindrops having refractive index of “1.38,” different from air having refractive index of “1,” adhere on the outer face of the windshield 105, the total reflection condition does not occur, and the light passes through the outer face of the windshield 105 at a portion where raindrops adhere. Therefore, the reflection light reflected at a non-adhering portion of the outer face of the windshield 105 where raindrops does not adhere is received by the image sensor 206 as an image having high intensity or luminance. By contrast, the quantity of the reflection light decreases at an adhering portion of the outer face of the windshield 105 where raindrops adhere, and thereby the light quantity received by the image sensor 206 decreases, and the reflection light is received by the image sensor 206 as an image having low intensity or luminance. Therefore, a contrast between the raindrop-adhering portion and the raindrop-non-adhering portion on the captured image can be obtained.

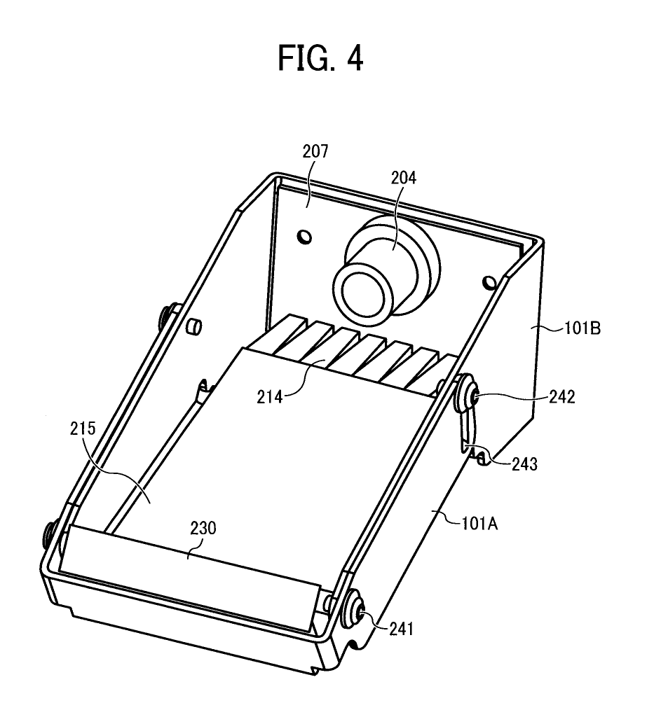

FIG. 4 illustrates a perspective view of a schematic configuration of the image capturing unit 101. The image capturing unit 101 includes, for example, a first module 101A and a second module 101B. The first module 101A, used as a first supporter, supports the reflective deflection prism 230 by fixing to the first module 101A, with which the reflective deflection prism 230 can be attached to the inner face of the windshield 105. The second module 101B, used as a second supporter, supports the sensor board 207 installed with the image sensor 206 and the LED 211, a tapered light guide 215, and the capture lens 204 by fixing each unit to the second module 101B.

The first and second modules 101A and 101B are linked with each other by a rotation mechanism 240, which includes a rotation axis 241 extending in a direction perpendicular to both of the slanting direction and the vertical direction of the windshield 105. The first module 101A and the second module 101B can be rotated or pivoted with each other about the rotation axis 241. This pivotable configuration is employed to set the image capturing direction of the image capture device 200 in the second module 101B to a specific target direction (e.g., horizontal direction) even if the first module 101A is fixed to the windshield 105 having different inclination angle.

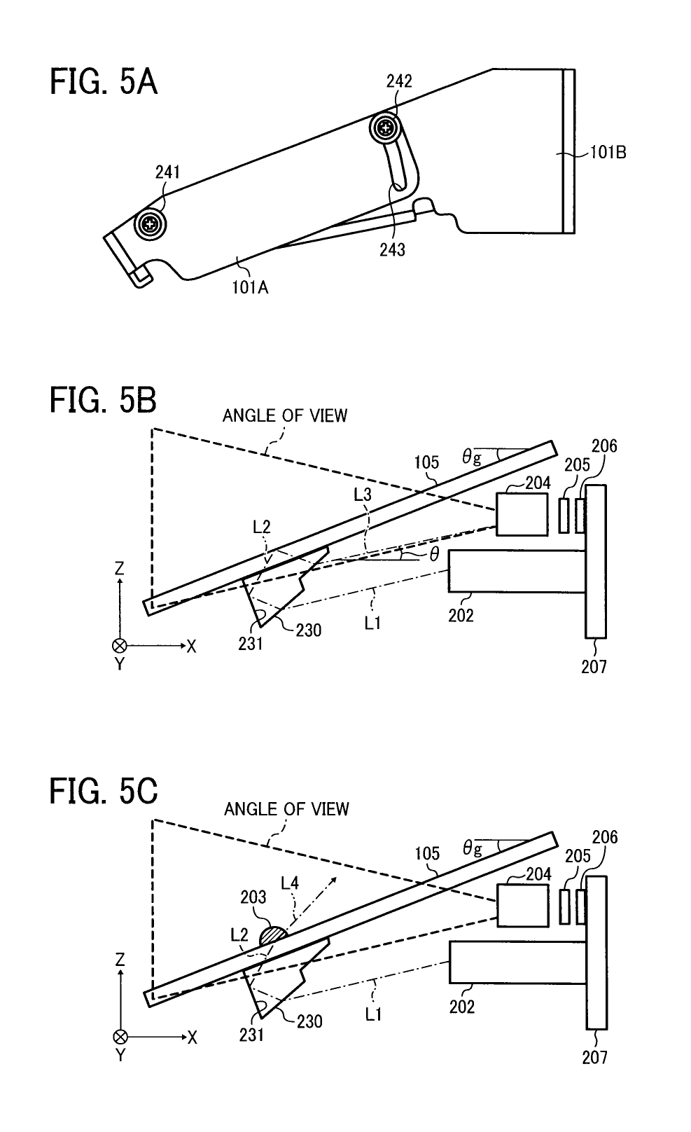

FIG. 5A illustrates a side view of the image capturing unit 101 attached to attached to the windshield 105 of a vehicle having an inclination angle θg of 22 degrees with respect to the horizontal direction. FIG. 5B illustrates an optical scheme of the image capturing unit 101 when raindrops do not adhere under the condition illustrated in FIG. 5A. FIG. 5C illustrates an optical scheme of the image capturing unit 101 when raindrops adhere under the condition illustrated in FIG. 5A.

Light L1 emitted from the light source unit 202 is regularly reflected on the reflection face 231 of the reflective deflection prism 230 as a reflection light L2, and the reflection light L2 passes through the inner face of the windshield 105. If raindrops do not adhere on the outer face of the windshield 105, the reflection light L2 totally reflects on the outer face of the windshield 105 as a reflection light L3, and the reflection light L3 passes through the inner face of the windshield 105 toward the capture lens 204. By contrast, if raindrop 203 adheres on the outer face of the windshield 105, the reflection light L2 regularly reflected on the reflection face 231 of the reflective deflection prism 230 passes through the outer face of the windshield 105. In such a configuration, if the inclination angle θg of the windshield 105 is changed, a posture of the first module 101A attached to the inner face of the windshield 105 can be changed while maintaining a posture of the second module 101B (e.g., maintaining the image capturing direction to the horizontal direction), in which the reflective deflection prism 230 is rotated about the Y-axis in FIG. 5 in view of the inclination angle θg of the windshield 105.

In the first example embodiment, a layout relationship of the reflection face 231 of the reflective deflection prism 230 and the outer face of the windshield 105 is set to a given configuration that the total reflection light L3 reflected at the outer face of the windshield 105 can be received constantly at a receiving area of the image sensor 206 used for detecting the change of conditions of the windshield 105 within the rotation adjustment range of the rotation mechanism 240. Hereinafter, this receiving area may be referred to as an adhered substance detection receiving area. Therefore, even if the inclination angle θg of the windshield 105 changes, the total reflection light L3 reflected at the outer face of the windshield 105 can be received by the adhered substance detection receiving area of the image sensor 206, by which a raindrops detection can be conducted effectively.

The layout relationship substantially satisfies the law of corner cube within the rotation adjustment range of the rotation mechanism 240. Therefore, even if the inclination angle θg of the windshield 105 changes, an angle θ defined by the optical axis direction of the total reflection light L3 reflected at the outer face of the windshield 105 and the horizontal direction is substantially constant. Therefore, the optical axis of the total reflection light L3 reflected at the outer face of the windshield 105 can pass a portion of the adhered substance detection receiving area of the image sensor 206 with a small deviation, by which the raindrops detection can be conducted effectively further.

When a layout of the reflection face 231 of the reflective deflection prism 230 and the outer face of the windshield 105 have a perpendicular relationship, the law of corner cube is satisfied. If the law of corner cube is substantially satisfied within the rotation adjustment range of the rotation mechanism 240, the layout relationship of the reflection face 231 of the reflective deflection prism 230 and the outer face of the windshield 105 is not limited to the perpendicular relationship. Even if the layout relationship of the reflection face 231 of the reflective deflection prism 230 and the outer face of the windshield 105 is not a perpendicular relationship, the angle θ defined for the optical axis of the total reflection light L3 going to the capture lens 204 can be substantially maintained at constant by adjusting an angle of other faces of the reflective deflection prism 230 (i.e., incident face and exit face) even if the inclination angle θg of the windshield 105 changes.

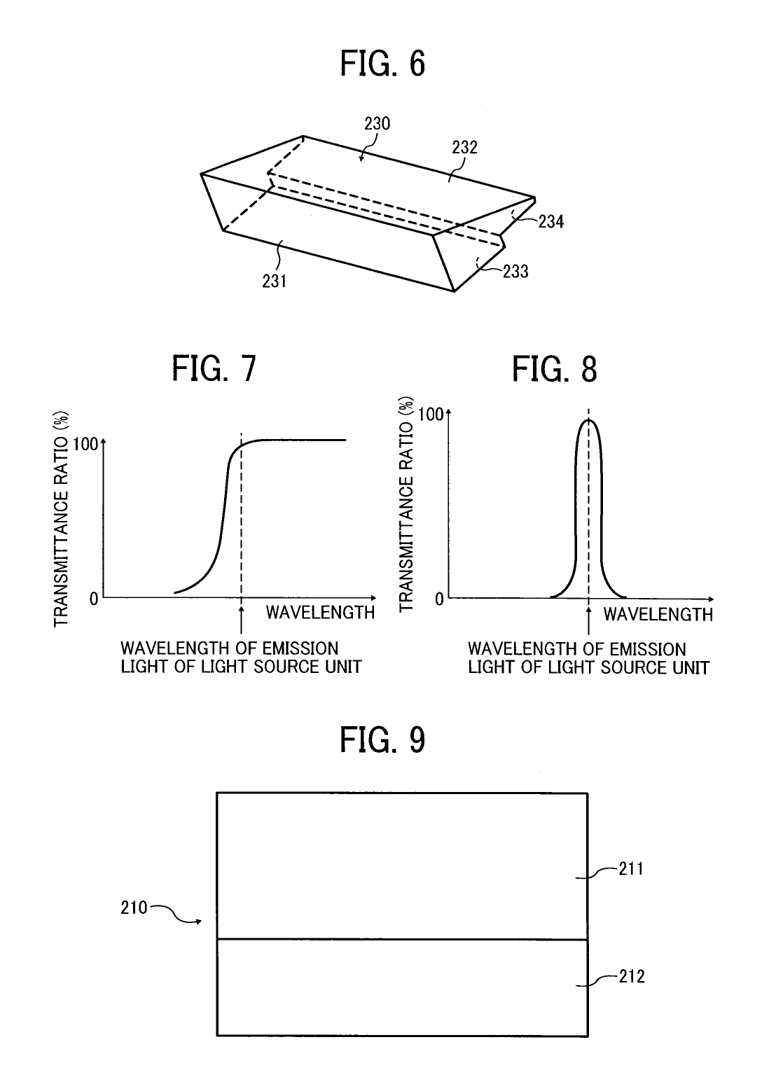

FIG. 6 illustrates a perspective view of the reflective deflection prism 230. The reflective deflection prism 230 includes the incidence face 223, the reflection face 231, the contact face 222, and the exit face 224. The light L1 emitting from the light source unit 202 enters the incidence face 223. The light L1 entering from the incidence face 223 is reflected on the reflection face 231. The contact face 222 is attached firmly to the inner face of the windshield 105. The reflection light L3 reflected at the outer face of the windshield 105 exits from the exit face 224 toward the image capture device 200. The incidence face 223 may be set in parallel to the exit face 224, but the incidence face 223 can be set not-in-parallel to the exit face 224.

The reflective deflection prism 230 can be made of materials that can pass through the light coming from the light source unit 202 such as glass, plastic, or the like. If the light coming from the light source unit 202 is infrared light, the reflective deflection prism 230 can be made of materials of dark color that can absorb visible lights. By employing materials that can absorb the visible light, it can reduce the intrusion of light (e.g., visible light from outside), which is other than the light coming from a LED (e.g., infrared light), to the reflective deflection prism 230.

Further, the reflective deflection prism 230 is formed to satisfy total reflection condition that can totally reflect the light coming from the light source unit 202 at the reflection face 231 within the rotation adjustment range of the rotation mechanism 240. Further, if it is difficult to satisfy total reflection condition at the reflection face 231 within the rotation adjustment range of the rotation mechanism 240, the reflection face 231 of the reflective deflection prism 230 can be formed with a layer of aluminum by vapor deposition to form a reflection mirror.

Further, although the reflection face 231 is a flat face, the reflection face can be a concave face. By using the concave reflection face, the diffused light flux entering the reflection face can be set parallel light flux. With this configuration, the reduction of light quantity on the windshield 105 can be suppressed.

When the image capture device 200 captures the infrared light reflected from the windshield 105, the image sensor 206 of the image capture device 200 receives infrared light emitted from the light source 210, and also ambient light coming as sun light including infrared light. Such ambient light includes infrared light having greater light quantity. To reduce the effect of the ambient light having greater light quantity to the infrared light coming from the light source 210, the light emission quantity of the light source 210 may be set greater than that of the ambient light. However, it is difficult to devise the light source 210 having the greater light emission quantity.

In view of this issue, in the first example embodiment, for example, a suitable cut-filter or a band-pass filter may be used. As illustrated in FIG. 7, a cut-filter that cuts light having a wavelength smaller than a wavelength of emission light of the light source unit 202 can be used. Further, as illustrated in FIG. 8, a band-pass filter that passes through light having a specific wavelength of emission light of the light source unit 202, substantially matched to the peak of transmittance ratio of the light of the light source unit 202, can be used. As such, the image sensor 206 can effectively receive light emitted from the light source 210 using these filters. By using these filters, light having a wavelength different from the wavelength of light emitted from the light source unit 202 can be removed. Therefore, the image sensor 206 can receive the light emitted from the light source unit 202 with quantity relatively greater than quantity of the ambient light. Therefore, without using the light source unit 202 having greater light emission intensity, the light emitted from the light source unit 202 can be effectively received by the image sensor 206 while reducing the effect of the ambient light.

In the first example embodiment, the raindrop 203 on the windshield 105 is detected based on the captured image data, and furthermore, the front-running vehicle (ahead vehicle) and the oncoming vehicle are detected, and the lane (e.g., white line) is also detected based on the captured image data. Therefore, if the light having a wavelength other than a wavelength of infrared light emitted from the light source unit 202 is removed from an entire image, the image sensor 206 cannot receive light having a wavelength required to detect the front-running vehicle (ahead vehicle)/oncoming vehicle and the lane, by which the detection of vehicle/oncoming vehicle and the lane cannot be conducted. In view of this issue, in the first example embodiment, an image area of captured image data is segmented to one detection image area used as an adhered substance (e.g., raindrop) detection image area, and another detection image area used as a vehicle detection image area. The adhered substance detection image area can be used to detect the raindrop 203 on the windshield 105. The vehicle detection image area can be used to detect the front-running vehicle (ahead vehicle)/oncoming vehicle, and the lane (e.g., white line). Therefore, the optical filter 205 includes a filter that can remove light having a wavelength band, which is other than infrared light emitted from the light source 210, wherein the filter is disposed for the optical filter 205 only for the adhered substance detection image area.

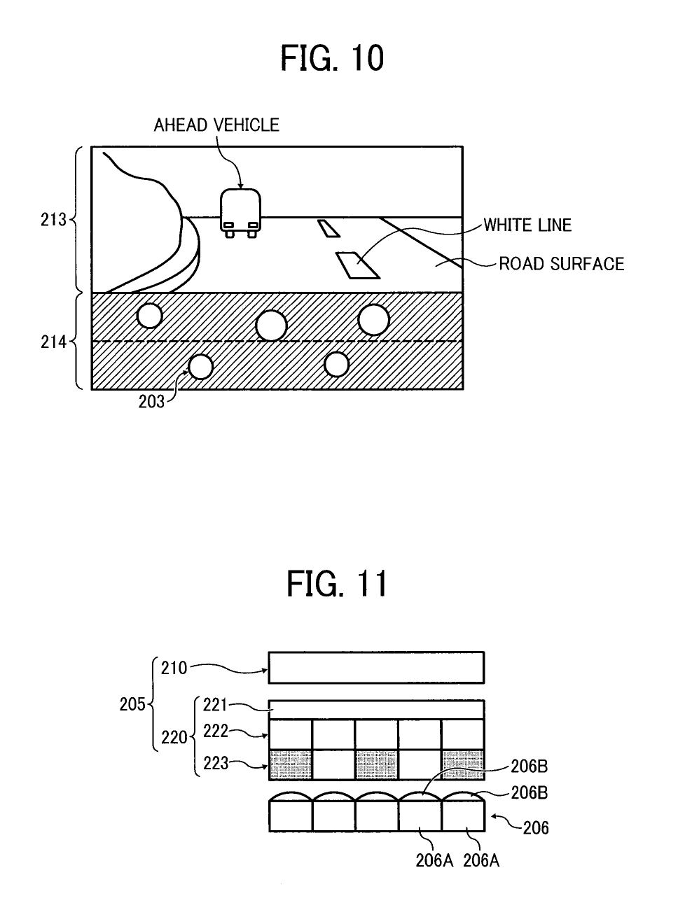

FIG. 9 illustrates a front view of a front-end filter 210 disposed for the optical filter 205. FIG. 10 illustrates an example of image generated from captured image data. As illustrated in FIG. 11, the optical filter 205 can be composed of the front-end filter 210 and the rear-end filter 220, stacked with each other in the light passing or propagation direction. As illustrated in FIG. 9, the front-end filter 210 can be segmented into one filter area such as an infrared cut-filter area 211, and another filter area such as an infrared transmittance-filter area 212. The infrared cut-filter area 211 is disposed for a vehicle detection image area 213, which may be an upper two-thirds (⅔) of one image capturing area while the infrared transmittance-filter area 212 is disposed for a raindrop detection image area 214, which may be a lower one-third (⅓) of one image capturing area. The infrared transmittance-filter area 212 may be devised by using the cut-filter illustrated in FIG. 7 or the band-pass filter illustrated in FIG. 8.

Typically, an image of headlight of the incoming vehicle, an image of tail lamp of the front-running vehicle (ahead vehicle), and an image of the lane (e.g., white line) present at the upper part of the image capturing area higher than the center portion of the captured image area, while an image of road surface, which exists in the front-direction and very close to the vehicle 100, presents at the lower part of the captured image area. Therefore, information required to recognize or identify the headlight of the incoming vehicle, the tail lamp of the front-running vehicle (ahead vehicle), and the lane is present mostly in the upper part of the image capturing area, and thereby information present in the lower part of the image capturing area may not be relevant for recognizing the incoming vehicle, the front-running vehicle (ahead vehicle), and the lane. Therefore, when an object detection process such as detecting the incoming vehicle, the front-running vehicle (ahead vehicle) and the lane, and a raindrop detection are to be conducted concurrently based on the captured image data, the lower part of the image capturing area is corresponded to the raindrop detection image area 214, and the upper part of the image capturing area is corresponded to the vehicle detection image area 213 as illustrated in FIG. 10. The front-end filter 210 is preferably segmented into one area corresponding to the vehicle detection image area 213 and another area corresponding to the raindrop detection image area 214.

As to the first example embodiment, the raindrop detection image area 214 is set under the vehicle detection image area 213 in the captured image data, but not limited hereto. For example, the raindrop detection image area 214 can be set above the vehicle detection image area 213, or the raindrop detection image area 214 can be set above and under the vehicle detection image area 213.

When the image capturing direction of the image capture device 200 is moved to a downward direction, a hood or bonnet of the vehicle 100 may appear at the lower part of the image capturing area. In such a case, sun light or the tail lamp of the front-running vehicle (ahead vehicle) reflected on the hood of the vehicle 100 becomes ambient light. If the ambient light is included in the captured image data, the headlight of the oncoming vehicle, the tail lamp of the front-running vehicle (ahead vehicle), and the lane may not be recognized correctly. In the first example embodiment, because the cut-filter (FIG. 7) or the band-pass filter (FIG. 8) can be disposed at a position corresponding to the lower part of the image capturing area, the ambient light such as sun light, and the light of tail lamp of the front-running vehicle (ahead vehicle) reflected from the hood can be removed. Therefore, the recognition precision of the headlight of the oncoming vehicle, the tail lamp of the front-running vehicle (ahead vehicle), and the lane can be enhanced.

Further, in the first example embodiment, due to the optical property of the capture lens 204, the upside/downside of an image in the image capturing area and the upside/downside of an image in the image sensor 206 becomes opposite. Therefore, if the lower part of the image capturing area is used as the raindrop detection image area 214, the upper part of the front-end filter 210 of the optical filter 205 may be configured using the cut-filter (FIG. 7) or the band-pass filter (FIG. 8).

The detection of the front-running vehicle (ahead vehicle) can be conducted by recognizing the tail lamp of the front-running vehicle (ahead vehicle) in the captured image. Compared to the headlight of the incoming vehicle, the light quantity of the tail lamp is small. Further, ambient light such as streetlamp/streetlight or the like may exist in the image capturing area. Therefore, the tail lamp may not be detected with high precision if only the light intensity data such as luminance data is used. To recognize the tail lamp effectively, spectrum information may be used. For example, based on received light quantity of the red-color light, the tail lamp can be recognized effectively. In the example embodiment, as described later, the rear-end filter 220 of the optical filter 205 may be disposed with a red-color filter or cyan-color filter matched to a color of the tail lamp, which is a filter that can pass through only a wavelength band matched to a color used for the tail lamp, so that the received light quantity of the red-color light can be detected effectively.

However, each of the light receiving elements configuring the image sensor 206 may have sensitivity set to infrared light. Therefore, if the image sensor 206 receives light including infrared light, the captured image may become red-color-like image as a whole. Then, it may become difficult to recognize a red-color image portion corresponding to the tail lamp. In view of such situation, in the first example embodiment, the front-end filter 210 of the optical filter 205 includes the infrared cut-filter area 211 corresponding to the vehicle detection image area 213. By employing such infrared cut-filter area 211, the infrared wavelength band can be removed from the captured image data used for the recognition of the tail lamp, by which the recognition precision of tail lamp can be enhanced.

FIG. 11 illustrates a schematic configuration of the optical filter 205 and the image sensor 206 corresponding to the vehicle detection image area 213 viewed from a direction perpendicular to the light passing or propagation direction. The image sensor 206 is a sensor employing, for example, a charge coupled device (CCD), a complementary metal oxide semiconductor (CMOS), or the like, and each of the light receiving elements of image sensor 206 may be, for example, photodiode 206A. The photodiodes 206A are arrayed as a two-dimensional array, in which each photodiode 206A may correspond to each pixel. To enhance the light collection efficiency of the photodiode 206A, a micro lens 206B is disposed at the incidence side of the photodiode 206A. The image sensor 206 can be bonded to a printed wiring board (PWB) using known methods such as wire bonding to configure the sensor board 207. Hereinafter, the photodiode 206A may mean one photodiode or a plurality of photodiodes.

The optical filter 205 is disposed at a close proximity of the micro lens 206B of the image sensor 206. As illustrated in FIG. 11, the rear-end filter 220 of the optical filter 205 corresponding to the vehicle detection image area 213 includes a translucent filter board 221, a polarized-light filter 222, and a light-separation filter 223. The rear-end filter 220 employs a multiple-layered structure by forming the polarized-light filter 222 on a translucent filter board 221, and then forming the light-separation filter 223 on the polarized-light filter 222. The polarized-light filter 222 and the light-separation filter 223 are segmented, and each polarized-light filter 222 and each light-separation filter 223 correspond to one of the photodiodes 206A of the image sensor 206.

The optical filter 205 and the image sensor 206 can be arranged in the image capture device 200 by setting a space between the optical filter 205 and the image sensor 206. Further, the optical filter 205 and the image sensor 206 can be arranged in the image capture device 200 by closely contacting the optical filter 205 to the image sensor 206, in which the boundary of the optical filter 205 including the polarized-light filter 222 and the light-separation filter 223, and the boundary of the photodiode 206A on the image sensor 206 can be matched easily. For example, the optical filter 205 and the image sensor 206 can be bonded, for example, using an ultra violet (UV) bonding agent, or the optical filter 205 and the image sensor 206 can be supported with each other by a spacer disposed therebetween at non-pixel areas not used for image capturing, and four sides of the optical filter 205 and the image sensor 206 can be bonded by UV bonding or heat bonding.

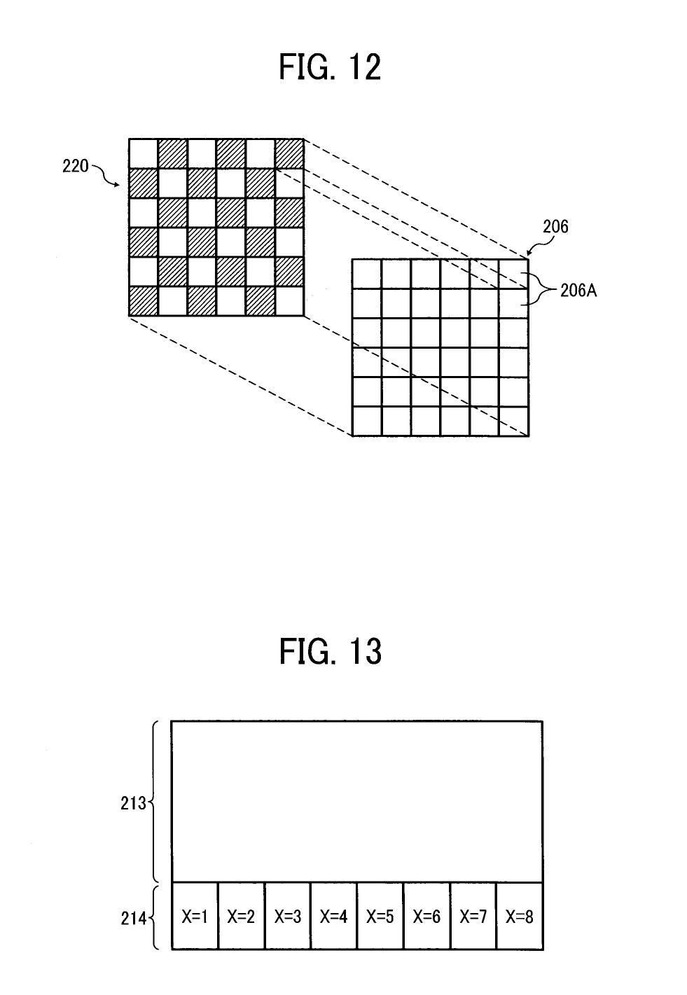

FIG. 12 illustrates an area segmentation pattern of the polarized-light filter 222 and the light-separation filter 223 of the rear-end filter 220 of the optical filter 205. The polarized-light filter 222 includes areas such as a first area and a second area, and the light-separation filter 223 includes areas such as the first area and the second area. Such first area and second area set for the polarized-light filter 222 and the light-separation filter 223 are matched to each corresponding photodiode 206A on the image sensor 206. With such a configuration, each photodiode 206A on the image sensor 206 can receive light that passes the first area and second area set for the polarized-light filter 222 or the light-separation filter 223. Depending on the types of area set for the polarized-light filter 222 or the light-separation filter 223, the polarized light information and spectrum information can be obtained by the image sensor 206. With this configuration, as to the first example embodiment, three types of captured image data can be acquired from the vehicle detection image area 213 by one image capturing operation, in which the three types of captured image data include perpendicular polarized light image of red-color light, perpendicular polarized light image of non-separated light, and horizontal polarized light image of non-separated light.

The perpendicular polarized light image of red-color light, which that can be obtained as such, can be used for the recognition of the tail lamp. Because the horizontal polarized light component S is cut from the perpendicular polarized light image of red-color light, a red-color image, having suppressed disturbance by the red color light having the horizontal polarized light component S having high intensity, can be obtained, wherein the red color light having the horizontal polarized light component S having high intensity may be red color light reflected from the road surface, and red color light reflected from the dash board or instrument panel disposed in the vehicle 100 and observed as a ghost image. Therefore, by using the perpendicular polarized light image of red-color light for the recognition process of the tail lamp, the recognition performance of the tail lamp can be enhanced.

Further, the perpendicular polarized light image of non-separated light, for example, can be used for recognition of the lane (e.g., white line) and the headlight of the incoming vehicle. Because the horizontal polarized light component S is cut from the horizontal polarized light image of non-separated light, a non-separated light image, having suppressed disturbance by white light having the horizontal polarized light component S having high intensity, can be obtained, wherein the white light having the horizontal polarized light component S having high intensity may be the light of headlight and streetlamp/streetlight reflected from the road surface, or a white light reflected from the dash board or instrument panel disposed in the vehicle 100 and observed as a ghost image. Therefore, by using the perpendicular polarized light image of non-separated light for the recognition process of the lane (e.g., white line) and the headlight of the incoming vehicle, the recognition performance of the lane (e.g., white line) and the headlight of the incoming vehicle can be enhanced. Especially, on the wet road, reflection light reflected from a wet area (e.g., water surface) covering the road surface has a greater quantity of the horizontal polarized light component S. Therefore, by using the perpendicular polarized light image of non-separated light for the recognition process of the lane (e.g., white line), the lane under the water area of the wet road can be effectively recognized, by which the recognition performance of the lane and the headlight of the incoming vehicle can be enhanced.

Further, the perpendicular polarized light image of non-separated light and the horizontal polarized light image of non-separated light can be compared with each other for each one of pixels, and a compared result can be used as pixel value or pixel index value. By using the pixel index value, a metal-object in the image capturing area, wet/dry conditions of the road surface, an object such as three-dimensional object in the image capturing area, and the lane (e.g., white line) on the wet road can be recognized with high precision. The captured images can be used as comparing images, which can be compared with each other using, for example, following values; 1) a difference between a pixel value of the perpendicular polarized light image of non-separated light and a pixel value of the horizontal polarized light image of non-separated light can be used difference-based image; 2) a ratio between a pixel value of the perpendicular polarized light image of non-separated light and a pixel value of the horizontal polarized light image of non-separated light can be used as a difference of image (ratio-based image); and 3) a difference of a pixel value of the perpendicular polarized light image of non-separated light and a pixel value of the horizontal polarized light image of non-separated light is divided by a sum of a pixel value of the perpendicular polarized light image of non-separated light and a pixel value of the horizontal polarized light image of non-separated light.

As to the raindrop detection image area 214, the infrared transmittance-filter area 212 of the front-end filter 210 of the optical filter 205 cut visible light range, and thereby an image of infrared light range, which is the emission wavelength of the light emitted from the light source unit 202, can be captured.

### (Detection Process of Raindrop on Windshield)

A description is given of a detection process of the raindrop according to an example embodiment. The detection of the raindrop on windshield (i.e., detection-target object) is conducted for the drive control of the wiper 107 and the dispensing control of washer fluid. In the following example, raindrop is described as substance adhered on the windshield, but the adhered substance is not limited to the raindrop. For example, excrements of birds, water splash from the road surface splashed by other vehicles becomes the adhered substance.

As above described, as to the first example embodiment, lighting light or detection-use light (e.g., infrared light) emitted from the light source unit 202 enters the inner face of the windshield 105 via the reflective deflection prism 230. The lighting light regularly reflects on a non-adhering portion of the outer face of the windshield 105 where raindrops does not adhere. This regularly reflected light is received by the image sensor 206, and generated on the raindrop detection image area 214. By contrast, the lighting light passes through an adhering portion of the outer face of the windshield 105 where raindrops adhere, and thereby the passing light is not received by the image sensor 206. Therefore, the captured image data using the raindrop detection image area 214 includes higher luminance image portion (higher pixel value) for the non-adhering portion of the outer face of the windshield 105 where raindrops does not adhere and lower luminance image portion (lower pixel value) for the adhering portion of the outer face of the windshield 105 where raindrops adhere. Based on this difference of luminance, it can determine whether raindrops exist, and raindrop quantity.

FIG. 13 is a schematic view of the vehicle detection image area 213 and thee raindrop detection image area 214 used for a raindrop detection process of the first example embodiment. In the raindrop detection process of the first example embodiment, if it is determined that the raindrop increases based on information of the raindrop detection image area 214 in the captured image data acquired from the image capturing unit 101, the wiper 107 is activated and driven. Specifically, the raindrop detection image area 214 can be divided into a plurality of segment such as eight segments (x=1 to 8) in the horizontal direction of the image as illustrated in FIG. 13, and a primary total luminance value “y(x, ta)” in each of the raindrop detection segments “x” is calculated, in which “ta” indicates the image capture timing of the light-ON period image frame.

Then, the raindrop detection condition can be determined based on the primary total luminance value “y(x, ta)” of each of the raindrop detection segment “x.” If the raindrop detection condition is satisfied, it is determined that a condition changes from a no-raindrop-adhering condition to a raindrop-adhering condition (i.e., raindrop increases), and the wiper 107 is activated and driven. By contrast, if it is determined that the no-raindrop-adhering detection is satisfied based on the primary total luminance value “y(x, ta)” of each of the raindrop detection segment “x,” the wiper 107 is deactivated or stopped. The conditions to start and stop the driving of the wiper 107 can be set variably as required. For example, a threshold is not limited to a fixed value, but the threshold can be variably changed as required depending on change of conditions near the vehicle mounted with the image capture device 200. Further, the threshold of activation and the threshold of stopping can be the same value or different values.

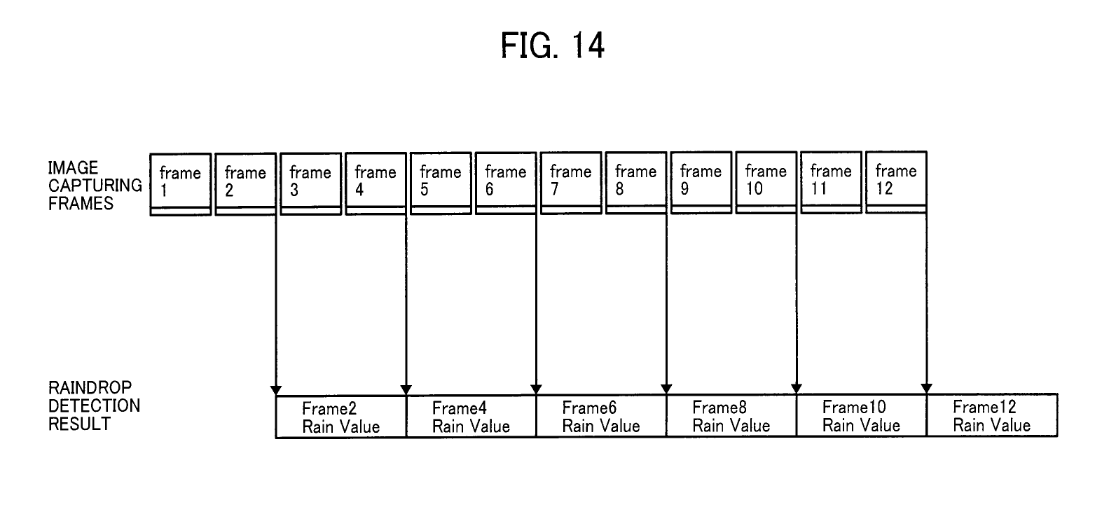

FIG. 14 is a scheme of a relationship of image capturing frames and the raindrop detection of the first example embodiment. Typically, an image capturing frame (i.e., sensing frame) used for detecting or identifying one or more target objects such as white line on roads (e.g., lanes) and other vehicles existing in the image capturing area, and an image capturing frame (i.e., raindrop detection frame) used for detecting the raindrop are set as different image capturing frames. However, in this configuration, a time difference occurs between one sensing frame captured before the raindrop detection frame is captured and another sensing frame captured after the raindrop detection frame is captured. Therefore, an image used for detecting or identifying the target objects cannot be captured during a time period between a first time point when the pervious sensing frame (first sensing frame) is captured and a second time point when the later sensing frame (second sensing frame) is captured, with which the detection or identifying precision of the target objects may not be performed effectively. Therefore, as to the first example embodiment, as illustrated in FIG. 14, the vehicle detection image area 213 used for detecting or identifying the target objects and the raindrop detection image area 214 used for detecting the raindrop 203 can be acquired by a single image capturing frame such as Frames 2, 4, 6, 8, 10, 12. With this configuration, the image capturing frame (raindrop detection frame) specifically used for detecting the raindrop 203 is not required, and thereby the above described problem may not occur.

As to the first example embodiment, an automatic exposure control (AEC) can be performed to change the exposure quantity depending on conditions (e.g., brightness) of the image capturing area to obtain a preferable image for the vehicle detection image area 213 (e.g., image area having higher contrast). Specifically, the exposure controller 102C of the image analyzer 102 can activate the automatic exposure control (AEC), in which the exposure time (exposure quantity) of the next image capturing frame is changed based on a luminance or brightness value at the center portion of the captured image area (i.e., pixel in the vehicle detection image area 213) in the previous image capturing frame.

When the automatic exposure control (AEC) is performed, the luminance and contrast of the raindrop detection image area 214 may change due to the change of the exposure time even if the raindrop adhering condition on the windshield 105 is being the same. In this case, the raindrop detection image area 214 having a first level of luminance and contrast and the raindrop detection image area 214 having a second level of luminance and contrast, different from the first level, are acquired, with which the raindrop quantity cannot be detected correctly, and erroneous activation of the wiper 107 may occur. Therefore, as to the first example embodiment, the exposure period can be changed by the automatic exposure control (AEC) during a time period when the light source unit 202 does not emit the detection-use light. With this configuration, even if the exposure period is changed, the light receiving time of the detection-use light by the image sensor 206 becomes constant during the light emitting period of the light source unit 202, and thereby the raindrop quantity can be detected correctly, and issues such as the erroneous activation of the wiper 107 can be prevented.

As to the first example embodiment, when the raindrop 203 adheres on the windshield 105, the detection-use light emitted from the light source unit 202 and reflected from the windshield 105 is received by the image sensor 206, in which the light quantity received by the image sensor 206 is decreased due to the adhesion of the raindrop 203, and the luminance value of the raindrop detection image area 214 is decreased, with which the raindrop 203 adhering on the windshield 105 can be detected. Specifically, a difference between the currently calculated primary total luminance value “y(x, ta)” of each of the raindrop detection segments “x” at the current time point and the most recently calculated primary total luminance value “y(x, ta−1)” of each of the raindrop detection segments “x” at the most recent previous time point is defined as a light-ON time difference “ey(x, ta)” indicating a raindrop-related variable factor, and the adhering of the raindrop 203 can be detected based on the raindrop-related variable factor.

As to the first example embodiment, the light-ON time difference “ey(x, ta)=y(x, ta)−y(x, ta−1)” indicates a changed quantity of the total luminance value (i.e., lighting-period changed quantity) between two time points when two light-ON period image frames are captured consecutively. During a time period when the two consecutive light-ON period image frames 2, 4, 6, 8, 10, 12 (ta=1, 2, 3, 4, 5, 6) are captured, the light-ON time difference “ey(x, ta)” may fluctuate by the raindrop-related variable factor such as fluctuation of the raindrop-adhering quantity due to the raindrop adhesion or the raindrop removement by the wiper 107, by an ambient-light-related variable factor such as the change of light quantity of ambient light that enters the image sensor 206, and by a non-ambient-light-related variable factor other than the ambient-light-related variable factor. If the ambient-light-related variable factor and/or the non-ambient-light-related variable factor are included in the light-ON time difference “ey(x, ta),” and the light-ON time difference “ey(x, ta)” including the ambient-light-related variable factor and/or the non-ambient-light-related variable factor is used as the light-ON time difference “ey(x, ta)” indicating the raindrop-related variable factor, the erroneous detection of raindrop may occur, and the erroneous activation of the wiper 107 may occur.

For example, the non-ambient-light-related variable factor includes a temperature-related variable factor and an aging-related variable factor. As to the temperature-related variable factor, optical properties of optical parts such as lens, mirror, and prism, and light-emission quantity of the light source fluctuate due to the temperature change, with which the luminance value of the raindrop detection image area 214 fluctuates. As to the aging-related variable factor, optical properties of optical parts such as lens, mirror, and prism, and light-emission quantity of the light source fluctuate due to the aging, with which the luminance value of the raindrop detection image area 214 fluctuates. The temperature-related variable factor and the aging-related variable factor fluctuate or change very slowly. Therefore, these factors may not cause a significant change to the light-ON time difference “ey(x, ta)” during a change monitoring period that monitors the light-ON time difference “ey(x, ta)” because these factors may change over a long period time that is longer than a time period used for capturing two consecutive light-ON period image frames. Therefore, the non-ambient-light-related variable factor can be excluded from factors that fluctuate the light-ON time difference “ey(x, ta).” Therefore, it can be estimated that the light-ON time difference “ey(x, ta)” can be fluctuated by the raindrop-related variable factor and/or the ambient-light-related variable factor.

Therefore, as to the first example embodiment, it is determined whether the ambient-light-related variable factor is included in the light-ON time difference “ey(x, ta)” indicating the changed quantity (lighting-period changed quantity) of the total luminance value at each of the raindrop detection segments “x,” and the light-ON time difference “ey(x, ta)” not including the ambient-light-related variable factor can be used as the raindrop-related variable factor. With this configuration, the raindrop can be detected correctly without receiving the effect of the ambient-light-related variable factor and the non-ambient-light-related variable factor, and the erroneous activation of the wiper 107 can be evaded.

The ambient-light-related variable factor can be obtained as follows. For example, as to the first example embodiment, as illustrated in FIG. 14, the light-ON and light-OFF of the light source unit 202 are alternately repeated for each of the image capturing frames to capture images. Specifically, as to odd number image capturing frames such as the image capturing frames 1, 3, 5, 7, 9, 11, image data is captured under a condition that the light source unit 202 is at the light-OFF condition (light-OFF image data), and as to even number image capturing frames such as the image capturing frames 2, 4, 6, 8, 10, 12, image data is captured under a condition that the light source unit 202 is at the light-ON condition (light-ON image data).

In this configuration, the light-OFF image data of the raindrop detection image area 214 acquired from the image capturing frames 1, 3, 5, 7, 9, 11 (tb=1, 2, 3, 4, 5, 6) corresponding to the light-OFF timing is image data that captures the ambient light alone, wherein the ambient light is the light other than the detection-use light emitted from the light source unit 202, in which “tb” indicates the image capture timing of the light-OFF period image frame. Therefore, the secondary total luminance value “d(x, tb)” in each of the raindrop detection segments “x” at the most recently calculated light-OFF period image frame can be assumed as the ambient light factor included in the primary total luminance value “y(x, ta)” at each of the raindrop detection segments “x” in the raindrop detection image area 214 acquired from the image capturing frame at the light-ON timing. Therefore, as to the first example embodiment, a difference of the secondary total luminance value “d(x, tb)” at each of the raindrop detection segments “x” for the currently calculated light-OFF period image frame and the secondary total luminance value “d(x, tb−1)” at each of the raindrop detection segments “x” for the most recently calculated light-OFF period image frame can be defined as a light-OFF time difference “ed(x, tb)” caused by the ambient-light-related variable factor.

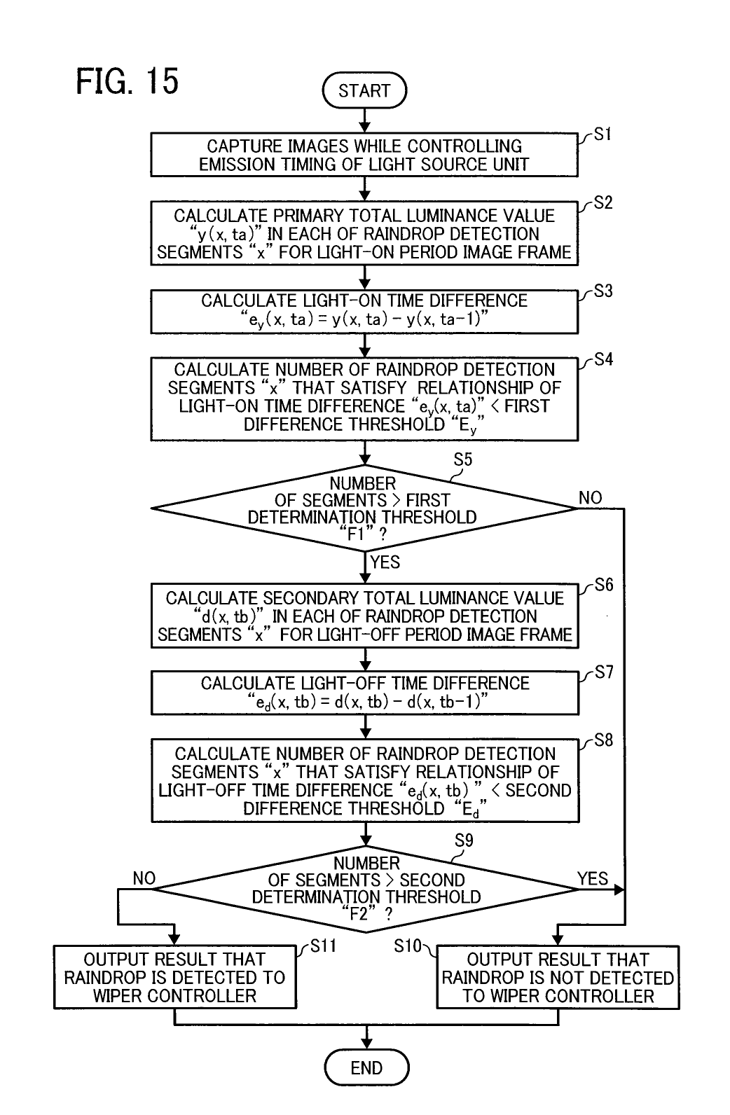

FIG. 15 is a flowchart illustrating the steps of the raindrop detection process of the first example embodiment. The light source controller 102B of the image analyzer 102 controls the light emission timing of the light source unit 202 while acquiring the image signals from the signal processor 208, and captures the light-OFF period image frames 1 and 3 (tb=1, 2) and the light-ON period image frames 2 and 4 (ta=1, 2) (step S1). Then, the detection processor 102A of the image analyzer 102 calculates the primary total luminance value “y(x, ta=1)” and “y(x, ta=2)” in each of the raindrop detection segments “x” of the raindrop detection image area 214 for the light-ON period image frames 2 and 4 (step S2), and calculates the light-ON time difference “ey (x, ta=2)=y(x, ta=2)−y(x, ta=1)” for each of the raindrop detection segments “x” (step S3).

When calculating the light-ON time difference “ey(x, ta=2),” the detection processor 102A of the image analyzer 102 acquires captured image data of the light-ON period image frame 2 (ta=1) from the image capturing unit 101. After calculating the primary total luminance value “y(x, ta=1)” for the light-ON period image frame 2 based on the acquired captured image data, the detection processor 102A stores the primary total luminance value “y(x, ta=1)” in a memory of the detection processor 102A temporarily, or delays the output of the primary total luminance value “y(x, ta=1).” Then, the detection processor 102A of the image analyzer 102 acquires next captured image data of the light-ON period image frame 4 from the image capturing unit 101, and calculates the primary total luminance value “y(x, ta=2).” Then, the detection processor 102A calculates the light-ON time difference “ey(x, ta=2) by using the previous primary total luminance value “y(x, ta=1) temporarily stored or delayed for output.

Then, the detection processor 102A determines whether the light-ON time difference “ey(x, ta=2)” of each of the raindrop detection segments “x” calculated as above described is smaller than a first difference threshold “Ey,” and calculate the number of the raindrop detection segments “x” having the light-ON time difference “ey(x, ta=2)” smaller than the first difference threshold “Ey” (step S4). In this processing, the first difference threshold “Ey” is set with a value that can detect a fluctuation amount of the light-ON time difference “ey(x, ta=2)” correctly when the raindrop-adhering quantity fluctuates due to the raindrop adhesion or the raindrop removement by the wiper 107. As to the first example embodiment, when the raindrop adheres, the total luminance value becomes smaller. Therefore, a value of the light-ON time difference “ey(x, ta)=y(x, ta)−y(x, ta−1)” when the raindrop adheres becomes a negative value, and thereby the first difference threshold “Ey” is set with a negative value.

In this processing, the light-ON time difference “ey(x, ta)” corresponding to the changed quantity (lighting-period changed quantity) of the primary total luminance value “y(x, ta)” in each of the raindrop detection segments “x” can be calculated by subtracting the primary total luminance value “y(x, ta−1)” of the most recently calculated light-ON period image frame from the primary total luminance value “y(x, ta)” of the currently calculated light-ON period image frame, but not limited hereto.

For example, the light-ON time difference “ey(x, ta)” can be calculated by subtracting the primary total luminance value “y(x, ta)” of the currently calculated light-ON period image frame from the primary total luminance value “y(x, ta−1)” of the most recently calculated the light-ON period image frame. In this case, since the total luminance value becomes smaller when the raindrop adheres for the first example embodiment, the light-ON time difference “ey(x, ta)=y(x, ta−1)−y(x, ta)” when the raindrop adheres becomes a positive value, and thereby the first difference threshold “Ey” is set with a positive value. In this case, at step S4, the number of the raindrop detection segments “x” having the light-ON time difference “ey(x, ta)” equal to the first difference threshold “Ey” or more is calculated for the raindrop detection segments “x”.

Further, the light-ON time difference “ey(x, ta)” can be defined as an absolute value of a difference of the primary total luminance value “y(x, ta−1)” of the most recently calculated light-ON period image frame and the primary total luminance value “y(x, ta)” of the currently calculated light-ON period image frame. In this case, since the total luminance value becomes smaller when the raindrop adheres for the first example embodiment, the light-ON time difference “ey(x, ta)=|y(x, ta)−y(x, ta−1)|” when the raindrop adheres becomes a positive value, and thereby the first difference threshold “Ey” is set with a positive value. In this case, at step S4, the number of the raindrop detection segments “x” having the light-ON time difference “ey(x, ta)” equal to the first difference threshold “Ey” or more is calculated for the raindrop detection segments “x.”

Further, the change monitoring period used for monitoring the changed quantity (lighting-period changed quantity) of the primary total luminance value “y(x, ta)” at each of the raindrop detection segments “x” can be set with any values as required. In this case, the light-ON time difference “ey(x, ta)” of two image capturing frames can be obtained by using two consecutive image capturing frames as above described, or by using two image capturing frames, which are spaced apart with each other by two or more image capturing frames.

Further, the changed quantity (lighting-period changed quantity) of the primary total luminance value “y(x, ta)” at each of the raindrop detection segments “x” can use an average value and/or a median value of a plurality of the total luminance values, which are close one to another along the time line, as a smoothed value along the time line. By smoothing along the time line, an effect of pulse noise that may in a very short time can be mitigated, and a risk that the lighting-period changed quantity becomes too great accidentally due the fluctuation of signals along the time line can be reduced.

After calculating the number of the raindrop detection segments “x” having the light-ON time difference “ey(x, ta=2)” smaller than the first difference threshold “Ey” (step S4), the detection processor 102A of the image analyzer 102 determines whether the calculated number of segments exceeds a first determination threshold “F1” (step S5), in which the first determination threshold “F1” can be set with any values as required. If the calculated number of segments becomes the first determination threshold “F1” or less (step S5: NO), the detection processor 102A determines that the raindrop is not detected, and the image analyzer 102 outputs a process result that the raindrop is not detected to the wiper controller 106 (step S10). Then, the wiper controller 106 controls operations such as deactivating the wiper 107.

By contrast, if the calculated number of segments exceeds the first determination threshold “F1” (step S5: YES), it can be estimated that the raindrop-adhering quantity has fluctuated due to the raindrop adhesion or the raindrop removement by the wiper 107, and the light-ON time difference “ey(x, ta=2)” may have fluctuated with a higher probability. However, this fluctuation of the light-ON time difference “ey(x, ta=2)” may be caused by the change of the light quantity of ambient light during the change monitoring period, corresponding to a time period for capturing two consecutive light-ON period image frames 2 and 4 and used for calculating the light-ON time difference “ey(x, ta=2).” Therefore, as to the first example embodiment, if it is determined that the light-ON time difference “ey(x, ta=2)” becomes smaller than the first difference threshold “Ey,” it is determined whether the ambient-light-related variable factor is included in the light-ON time difference “ey(x, ta=2)” determined as smaller than the first difference threshold “Ey.”

Specifically, the detection processor 102A of the image analyzer 102 calculates the secondary total luminance values “d(x, tb=1)” and “d(x, tb=2)” in each of the raindrop detection segments “x” of the raindrop detection image area 214 for the light-OFF period image frames 1 and 3 (step S6). Then, the detection processor 102A calculates the light-OFF time difference “ed(x, tb=2)=d(x, tb=2)−d(x, tb=1)” for each of the raindrop detection segments “x” (step S7). The calculation of the light-OFF time difference “ed(x, tb=2)” can be performed similar to the calculation of the light-ON time difference “ey(x, ta=2).”

Then, the detection processor 102A determines whether the light-OFF time difference “ed(x, tb=2)” calculated for each of the raindrop detection segments “x” is smaller than a second difference threshold “Ed” to calculate the number of the raindrop detection segments “x” having the light-OFF time difference “ed(x, tb=2)” smaller than the second difference threshold “Ed” (step S8). Since the light-OFF time difference “ed(x, tb)=d(x, tb)−d(x, tb−1)” of the ambient-light-related variable factor, which may be mistakenly detected or recognized as the raindrop-related variable factor, becomes a negative value, the second difference threshold “Ed” is set with a negative value. Further, step S8 of determining whether the light-OFF time difference “ed(x, tb=2)” is smaller than the second difference threshold “Ed” can be performed only to the raindrop detection segment “x” having determined that the light-ON time difference “ey(x, ta=2)” is smaller than the first difference threshold “Ey” calculated at the above described step S4

Further, the changed quantity (non-lighting-period changed quantity) of the secondary total luminance value “d(x, tb)” in each of the raindrop detection segments “x” is defined by the light-OFF time difference “ed(x, tb)” obtained by subtracting the secondary total luminance value “d(x, tb−1)” of the most recently calculated light-OFF period image frame from the secondary total luminance value “d(x, tb)” of the currently calculated the light-OFF period image frame, but not limited hereto.

For example, the light-OFF time difference “ed(x, tb)” can be obtained by subtracting the secondary total luminance value “d(x, tb)” of the currently calculated light-OFF period image frame from the secondary total luminance value “d(x, tb−1)” of the most recently calculated light-OFF period image frame. In this case, since the total luminance value becomes smaller when the raindrop adheres for the first example embodiment, the light-OFF time difference “ed(x, tb)=d(x, tb−1)−d(x, tb)” becomes a positive value when the light quantity of ambient light, mistakenly detected as the raindrop-related variable factor, is decreased, and thereby the second difference threshold “Ed” is set with a positive value. In this case, at step S8, the number of the raindrop detection segments “x” having the light-OFF time difference “ed(x, tb)” equal to the second difference threshold “Ed” or more is calculated for the raindrop detection segments “x.”

Further, for example, the light-OFF time difference “ed(x, tb) can be defined as an absolute value of a difference of the secondary total luminance value “d(x, tb−1)” of the most recently calculated light-OFF period image frame and the secondary total luminance value “d(x, tb)” of the currently calculated light-OFF period image frame. In this case, since the total luminance value becomes smaller when the raindrop adheres for the first example embodiment, the light-OFF time difference “ed(x, tb)”=|d(x, tb)−d(x, tb−1)|” becomes a positive value when the light quantity of ambient light, mistakenly detected as the raindrop-related variable factor, is decreased, and thereby the second difference threshold “Ed” is set with a positive value. In this case, at step S8, the number of the raindrop detection segments “x” having the light-OFF time difference “ed(x, tb)” equal to the second difference threshold “Ed” or more is calculated for the raindrop detection segments “x.”

Further, the change monitoring period used for monitoring the changed quantity (non-lighting-period changed quantity) of the secondary total luminance value “d(x, tb)” at each of the raindrop detection segments “x” can be set with any values as required. In this case, the light-OFF time difference “ed(x, tb)” of two image capturing frames can be obtained by using two consecutive image capturing frames as above described, or by using two image capturing frames, which are spaced apart with each other by two or more image capturing frames.

The change monitoring period used for calculating the light-OFF time difference “ed(x, tb)” is not required to be exactly matched to the change monitoring period used for calculating the above described the light-ON time difference “ey(x, ta),” but the change monitoring period used for calculating the light-OFF time difference “ed(x, tb)” is preferably matched closer to the change monitoring period used for calculating the above described the light-ON time difference “ey(x, ta).” For example, the light-OFF time difference corresponding to the light-ON time difference “ey(x, ta=2)” can be set as the light-OFF time difference “ed(x, tb=3)−ed(x, tb=2)” or “ed(x, tb=3)−ed(x, tb=1).”

After calculating the number of the raindrop detection segments “x” having the light-OFF time difference “ed(x, ta=2)” smaller than the second difference threshold “Ed” (step S8), the detection processor 102A of the image analyzer 102 determines whether the calculated number of segments exceeds a second determination threshold “F2” (step S9). The second determination threshold F2 can be set with any values as required. If the calculated number of segments becomes the second determination threshold F2 or less (step S9: NO), the detection processor 102A determines that the above described light-ON time difference “ey(x, ta=2)” smaller than the first difference threshold “Ey” is not caused by the change of light quantity of ambient light, but the detection processor 102A determines that the above described light-ON time difference “ey(x, ta=2)” smaller than the first difference threshold “Ey” is caused by fluctuation of the raindrop-adhering quantity such as the raindrop adhesion or the raindrop removement by the wiper 107. Therefore, the detection processor 102A determines that the raindrop is detected, and the image analyzer 102 outputs a process result that the raindrop is detected to the wiper controller 106 (step S11). Then, the wiper controller 106 controls operations such as activating the wiper 107.

By contrast, if the calculated number of segments exceeds the second determination threshold “F2” (step S9: YES), it can be estimated that the above described light-ON time difference “ey(x, ta=2)” smaller than the first difference threshold “Ey” is caused by the change of light quantity of ambient light with a higher probability. Therefore, the detection processor 102A determines that the raindrop is not detected, and the image analyzer 102 outputs a process result that the raindrop is not detected to the wiper controller 106 (step S10). Then, the wiper controller 106 controls operations such as deactivating the wiper 107.

The above described raindrop detection process is performed after capturing an image of the light-ON period image frame 4 (ta=2). When this raindrop detection process is completed, the similar raindrop detection process can be performed after capturing an image of the light-ON period image frame 6 (ta=3). In this case, the light-ON time difference is defined as “ey(x, ta=3)=y(x, ta=3)−y(x, ta=2),” and the light-OFF time difference is defined as “ed(x, tb=3)=d(x, tb=3)−d(x, tb=2).” As such, the raindrop detection process can be performed repeatedly when the capability of raindrop adhesion detection is activated.

Further, as to the first example embodiment, the light-OFF time difference “ed(x, tb)” may fluctuate due to the ambient-light-related variable factor, but not limited hereto. For example, the light-OFF time difference “ed(x, tb)” may also fluctuate due to an unintended automatic correction process of the image sensor 206, or malfunction of the image sensor 206 and the light source unit 202. Specifically, the image sensor 206 may be designed to have various capabilities such as the automatic exposure control (AEC) and automatic level correction control. Therefore, if these capabilities are activated by mistake or error, the primary total luminance value “y(x, ta)” of each of the raindrop detection segments “x” may fluctuate. Further, when the malfunction occurs to the light receiving element of the image sensor 206, the output signals output from the image sensor 206 may have a greater or smaller values locally.

Since the light-OFF time difference “ed(x, tb)” fluctuates little most of the time, the calculated light-OFF time difference “ed(x, tb)” can be used for detecting the malfunction of the image sensor 206 and the light source unit 202 or an erroneous activation of the automatic correction process of the image sensor 206. Specifically, if the light-OFF time difference “ed(x, tb)” exceeds a given abnormality determination threshold, it is determined that abnormality occurs. Since the unintended automatic correction process of the image sensor 206, or the malfunction of the image sensor 206 and the light source unit 202 cannot be identified differently from the raindrop adhesion just by using the captured image data of the light-ON period image frame, the captured image data of the light-OFF period image frame is preferably used.

Further, as to the first example embodiment, the raindrop detection condition includes a condition that the number of the raindrop detection segments “x” having the light-ON time difference “ey(x, ta)” smaller than the first difference threshold “Ey” exceeds the first determination threshold “F1.” However, the raindrop detection condition can use other condition instead of this condition, or other condition in addition to this condition. For example, an average value and variance value of the light-ON time difference “ey(x, ta)” for all of the raindrop detection segments “x” can be computed, and then it is determined whether the computed value is greater or smaller than a given threshold. This configuration can effectively enhance resistance to noise, which may occur locally.

Further, the changed quantity (lighting-period changed quantity) of the primary total luminance value “y(x, ta)” for each of the raindrop detection segments “x” can be defined as the light-ON time difference “ey(x, ta)” indicating a difference between the currently calculated primary total luminance value “y(x, ta)” and the most recently calculated primary total luminance value “y(x, ta−1)” for each of the raindrop detection segments “x.” But other condition using other parameter can be employed. For example, a pixel-based difference value between the currently calculated pixel values and the most recently calculated pixel values can be computed for each of pixels in each of the raindrop detection segments “x.” Then, the number of pixels having the pixel-based difference value greater than a given threshold or the number of pixels having the pixel-based difference value smaller than the given threshold can be used as parameters instead of the light-ON time difference “ey(x, ta).” In this case, even if the raindrop adheres locally in each of the raindrop detection segments “x,” the raindrop can be detected correctly and effectively.

Further, for example, an average value and a variance value of the pixel-based difference value in each of the raindrop detection segments “x” can be computed, and then it is determined whether the computed value becomes greater or smaller than a given threshold. This configuration can effectively enhance resistance to noise, which may occur locally in each of the raindrop detection segments “x.” However, the pixel-based difference value may generate a result that positive and negative values are inverted locally. Therefore, if the raindrop detection condition is simply determined based on the average value of the pixel-based difference values, the raindrop-related variable factor may be evaluated too small. Therefore, for example, a condition that the total of absolute values of the pixel-based difference value in each of the raindrop detection segments “x” exceeds a given threshold can be set and used.

Since the raindrops adhere on the windshield 105 unevenly in space, the pixel-based difference values in each of the raindrop detection segments “x” occur unevenly in space. Therefore, the variance value of the pixel-based difference value in each of the raindrop detection segments “x” can be used to determine the raindrop detection condition. Further, to be described later as a second example embodiment, if the detection-use light is refracted and reflected by the raindrop, the detection-use light is locally focused on the image sensor 206, and the pixel-based difference value for each of the raindrop detection segments “x” may locally increase. This pixel-based difference value can be used to determine the raindrop detection condition.

Further, as to the first example embodiment, it is determined whether the raindrop is detected, but not limited hereto. For example, based on the light-ON time difference “ey(x, ta),” the raindrop adhering quantity per unit time can be estimated, and the estimated raindrop quantity can be output as a raindrop-being-detected result. In this case, for example, the wiper controller 106 can selectively control an operation speed of the wiper 107 such as operation modes of “Low, High, Interval” depending on the raindrop quantity acquired from the image analyzer 102.

### Variant Example 1

A description is given of one variant example of the first example embodiment (hereinafter, variant example 1). As to the variant example 1, when a process result of the raindrop detection process indicates the raindrop-being-detected results consecutively, and when a process result of the raindrop detection process indicates the raindrop-not-being-detected results consecutively, the raindrop detection condition to be used for the subsequent raindrop detection process can be changed. Specifically, for example, if the raindrop-not-being-detected results are obtained consecutively, it can be estimated that it is not raining with a higher probability, in which the detection condition is changed to lower the detection sensitivity of the raindrop, with which the erroneous detection of raindrop can be reduced. By contrast, if the raindrop-being-detected results are obtained consecutively, it can be estimated that it is raining with a higher probability, in which the detection condition is changed to increase the detection sensitivity of the raindrop. With this configuration, a possibility of miss detection of raindrop can be reduced.

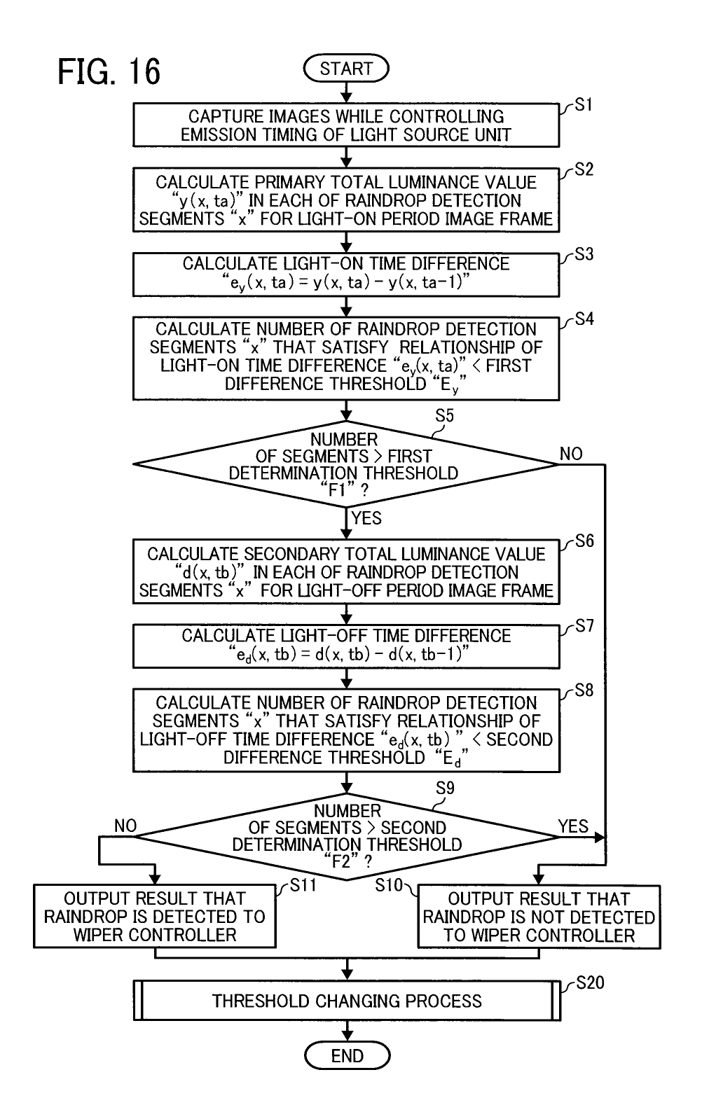

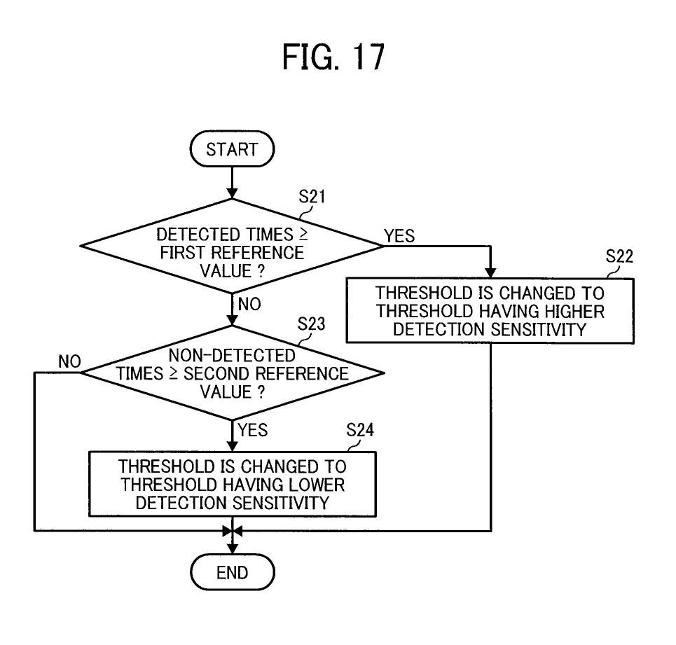

FIG. 16 is a flowchart illustrating the steps of the raindrop detection process of the variant example 1. FIG. 17 is a flowchart illustrating the steps of a threshold changing process of the variant example 1. The raindrop detection process of the variant example 1 is almost same as the above described first example embodiment, but as illustrated in FIG. 16, a threshold changing process is performed (step S20) for the raindrop detection process. In this threshold changing process, as illustrated in FIG. 17, it is determined whether the number of raindrop-detected times becomes a first reference value or more within a given condition changeable period (step S21). With this configuration, it can determine whether the raindrop-adhering quantity is increasing, and it can determine a frequency level of detecting the raindrop adhesion. Based on these determination results, it can determine whether it is raining.

Further, instead of the number of raindrop-detected times within the given condition changeable period, the number of raindrop-not-detected times within the given condition changeable period can be used, and further both of the number of raindrop-detected times and the number of raindrop-not-detected times within the given condition changeable period can be used to determine whether it is raining. Specifically, it is determined whether the number of raindrop-not-detected times becomes less than a given reference value. Further, instead of the number of raindrop-detected times within the given condition changeable period, a ratio of the number of raindrop-detected times and the number of raindrop-not-detected times can be used as a parameter to determine whether it is raining.

If it is determined that the number of raindrop-detected times becomes the first reference value or more within the given condition changeable period (step S21: YES), it is determined that it is raining. Then, at least one threshold related to the detection condition for the subsequent raindrop detection process is changed to a threshold having higher detection sensitivity of the raindrop (step S22). Specifically, the first difference threshold “Ey” (e.g., negative value) can be changed to a greater threshold (i.e., negative value having smaller absolute value), the first determination threshold “F1” can be changed to a smaller threshold, the second difference threshold “Ed” (e.g., negative value) can be changed to a smaller threshold (i.e., negative value having greater absolute value), or the second determination threshold “F2” can be changed to a greater threshold. Further, a given threshold range defined by a maximum value and a minimum value can be pre-set for each of the thresholds, with which the threshold changing process can be performed not to update the threshold if the threshold exceeds the threshold range.

Further, a method to enhance the detection sensitivity can be changed depending on the raindrop detection conditions. For example, as above described, if the raindrop detection condition includes a condition that the number of pixels having the pixel-based difference value smaller than a given pixel-based difference value threshold for each of the raindrop detection segments “x” exceeds a given number threshold, the detection sensitivity can be enhanced by increasing the pixel-based difference value threshold, and/or decreasing the number threshold. Further, for example, as above described, if the raindrop detection condition includes a condition that the number of pixels having an average value and variance value of the pixel-based difference value greater than a given average threshold or a given variance threshold in each of the raindrop detection segments “x” exceeds a given number threshold, the detection sensitivity can be enhanced by decreasing the average threshold and the variance threshold, and/or decreasing the number threshold.

By contrast, if it is determined that the number of raindrop-detected times within the given condition changeable period becomes less than the first reference value (step S21: NO), it is determined whether the number of raindrop-not-detected times within the given condition changeable period becomes a second reference value or more (step S23). With this configuration, it can determine a frequency level of not detecting the raindrop adhesion, and it can determine whether it is not raining.

If it is determined that the number of raindrop-not-detected times within the given condition changeable period becomes the second reference value or more (step S23: YES), it is determined that it is not raining. Then, at least one threshold related to the detection condition for the subsequent raindrop detection process can be changed to a threshold having a lower detection sensitivity of the raindrop (step S24). Specifically, the first difference threshold “Ey” (e.g., negative value) can be changed to a smaller threshold (i.e., negative value having a greater absolute value), the first determination threshold “F1” can be changed to a greater threshold, the second difference threshold “Ed” (e.g., negative value) is changed to a greater threshold (i.e., a negative value having a smaller absolute value), or the second determination threshold “F2” can be changed to a smaller threshold. Further, a given threshold range defined by a maximum value and a minimum value can be pre-set for each of the thresholds, with which the threshold changing process can be performed not to update the threshold if the threshold exceeds the threshold range. Further, the method to set a lower detection sensitivity can be changed depending on the raindrop detection conditions similar to the above described method to set a higher detection sensitivity.

By contrast, if the number of raindrop-detected times within the given condition changeable period is smaller than the first reference value (step S21: NO) and the number of raindrop-not-detected times within the given condition changeable period is smaller than the second reference value (step S23: NO), the raindrop detection process is completed without changing one or more thresholds.

As to the variant example 1, the detection sensitivity of raindrop can be changed by changing the one or more thresholds related to the raindrop detection condition, but the method of changing the detection sensitivity of raindrop is not limited hereto. For example, instead of changing the one or more thresholds related to the raindrop detection condition, or in addition to changing the one or more thresholds related to the raindrop detection condition, parameters used for determining the raindrop detection condition can be variably changed to change the detection sensitivity of raindrop. Specifically, if the results of the raindrop detection process indicates that the raindrop is being detected consecutively or the raindrop is not being detected consecutively, the duration of the change monitoring period of the light-ON time difference “ey(x, ta)” tar and the light-OFF time difference “ed(x, tb)” to be used for the subsequent raindrop detection processes can be changed.

For example, if it is determined that the number of raindrop-detected times within the given condition changeable period becomes the first reference value or more (step S21: YES), it is determined that it is raining, and then the duration of the change monitoring period of the light-ON time difference “ey(x, ta)” to be used for the subsequent raindrop detection processes can be set longer. Specifically, when a normal light-ON time difference is set as “ey(x, ta)=y(x, ta)−y(x, ta−1),” the light-ON time difference can be changed, for example, to the light-ON time difference “ey(x, ta)=y(x, ta)−y(x, ta−2)” or “ey(x, ta)=y(x, ta)−y(x, ta−3).” With this setting, the number of segments having the light-ON time difference “ey(x, ta)” smaller than the first difference threshold “Ey” can be increased for the subsequent raindrop detection processes, with which the frequency level of detecting the raindrop adhesion can be increased for the subsequent raindrop detection processes.

Further, for example, if it is determined that the number of raindrop-detected times within the given condition changeable period becomes the first reference value or more (step S21: YES), the duration of the change monitoring period of the light-OFF time difference “ed(x, tb)” to be used for the subsequent raindrop detection processes can be set shorter. Specifically, when a normal light-OFF time difference is set as “ed(x, tb)=d(x, tb)−d(x, tb−2),” the light-OFF time difference can be changed, for example, to the light-OFF time difference “ed(x, tb)=“d(x, tb)−d(x, tb−1).” With this setting, the number of segments having the light-OFF time difference “ed(x, tb)” smaller than the second difference threshold “Ed” can be decreased for the subsequent raindrop detection processes, with which the frequency level of detecting the raindrop adhesion can be increased for the subsequent raindrop detection processes.

Further, for example, if it is determined that the number of raindrop-not-detected times within the given condition changeable period becomes the second reference value or more (step S23: YES), the duration of the change monitoring period of the light-ON time difference “ey(x, ta)” to be used for the subsequent raindrop detection processes can be set shorter. Specifically, when a normal light-ON time difference is set as “ey(x, ta)=y(x, ta)−y(x, ta−2),” the light-ON time difference can be changed, for example, to the light-ON time difference “ey(x, ta)=y(x, ta)−y(x, ta−1).” With this setting, the number of segments having the light-ON time difference “ey(x, ta)” smaller than the first difference threshold “Ey” can be decreased for the subsequent raindrop detection processes, with which the frequency level of detecting the raindrop adhesion can be decreased for the subsequent raindrop detection processes.

Further, for example, if it is determined that the number of raindrop-not-detected times within the given condition changeable period becomes the second reference value or more (step S23: YES), the duration of the change monitoring period of the light-OFF time difference “ed(x, tb)” to be used for the subsequent raindrop detection processes can be set longer. Specifically, when a normal light-OFF time difference is set as “ed(x, tb)=d(x, tb)−d(x, tb−1),” the light-OFF time difference can be changed, for example, to the light-OFF time difference “ed(x, tb)=d(x, tb)−d(x, tb−2).” With this setting, the number of segments having the light-OFF time difference “ed(x, tb)” smaller than the second difference threshold “Ed” can be increased for the subsequent raindrop detection processes, with which the frequency of detecting the raindrop adhesion can be decreased for the subsequent raindrop detection processes.

Further, when the duration of the change monitoring period of the light-ON time difference “ey(x, ta)” is changed as above described, preferably, the duration of the change monitoring period of the light-OFF time difference “ed(x, tb)” is also changed in line with the change of the duration of the change monitoring period of the light-ON time difference “ey(x, ta).” Further, when the duration of the change monitoring period of the light-OFF time difference “ed(x, tb)” is changed, as above described, preferably, the duration of the change monitoring period of the light-ON time difference “ey(x, ta)” is also changed in line with the change of the duration of the change monitoring period of the light-OFF time difference “ed(x, tb).”

However, if the duration of the change monitoring period of the light-ON time difference “ey(x, ta)” and the duration of the change monitoring period of the light-OFF time difference “ed(x, tb)” used for the raindrop detection process are changed, a response speed of the raindrop detection is also changed. For example, the longer the duration of the change monitoring period of the light-ON time difference “ey(x, ta)” and the light-OFF time difference “ed(x, tb),” the higher the detection sensitivity of raindrop, but this method decreases the response speed of the raindrop detection because a time point for detecting fluctuation of the raindrop is delayed longer from a time point when the raindrop fluctuation actually occurs. Therefore, when the duration of the change monitoring period of the light-ON time difference “ey(x, ta)” and the duration of the change monitoring period of the light-OFF time difference “ed(x, tb)” used for the raindrop detection process are changed, the duration of the change monitoring period is preferably changed in view a relationship of the detection sensitivity of raindrop and the response speed of the raindrop detection.

### Variant Example 2

A description is given of another variant example of the first example embodiment (hereinafter, variant example 2). When the wiper 107 moves on a lighting area of the detection-use light on the windshield 105 or a non-lighting area of the detection-use light on the windshield 105, waterdrops adhered to the wiper 107 may adhere on the lighting area of the detection-use light on the windshield 105 due to the movement of the wiper 107. This waterdrop adhesion may be falsely detected as the raindrop adhesion, and then the erroneous activation of the wiper 107 may occur. For example, if the wiper 107 wipes or removes raindrops during the raining and waterdrops adhere on the wiper 107, the waterdrops adhered on the wiper 107 may adhere on the lighting area of the detection-use light on the windshield 105 after the rain stops, and this waterdrop adhesion may be falsely detected as the raindrop adhesion, and then the erroneous activation of the wiper 107 may occur even if it is not raining.

Therefore, as to the variant example 2, it is determined whether the raindrop detection process is to be performed based on an operation timing of the wiper 107. Specifically, when the wiper 107 comes to a timing of passing the lighting area of the detection-use light on the windshield 105, the raindrop detection process is suspended, and when the wiper 107 moves outside the lighting area of the detection-use light on the windshield 105, the raindrop detection process is resumed.

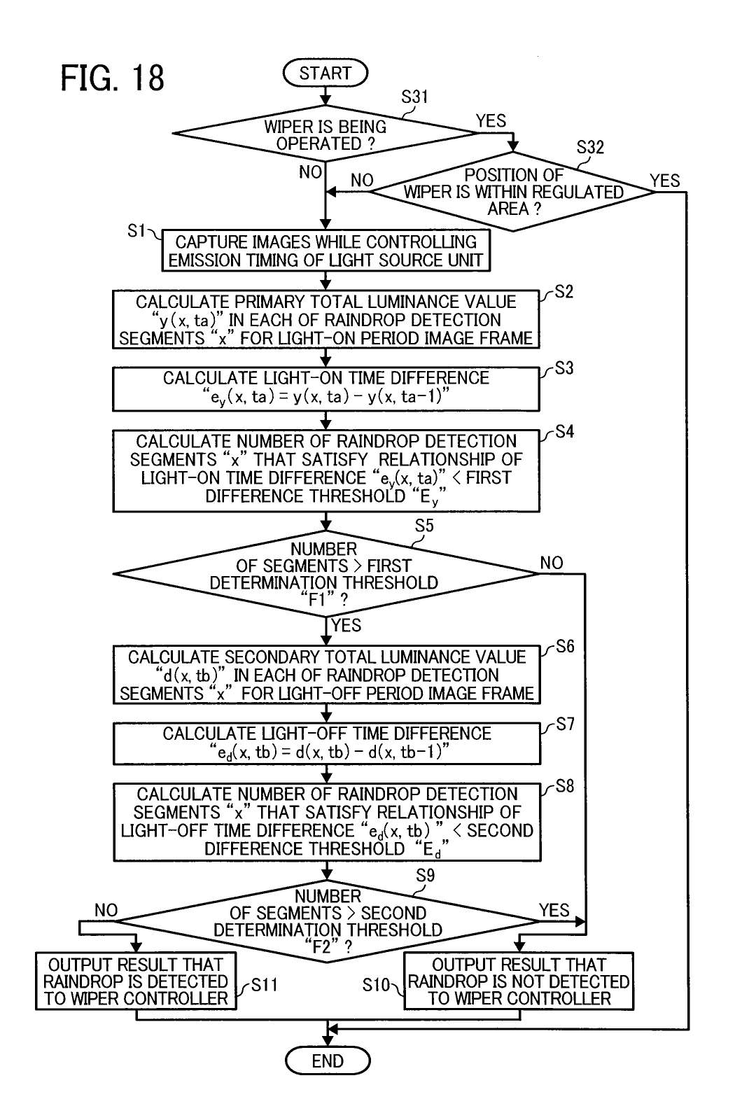

FIG. 18 is a flowchart illustrating the steps of the raindrop detection process of the variant example 2. The raindrop detection process of the variant example 2 is almost same as the raindrop detection process of the first example embodiment. As illustrated in FIG. 18, as to the variant example 2, it is determined whether the wiper 107 is being operated (step S31). If the wiper 107 is not being operated (step S31: NO), the raindrop detection process is performed same as the first example embodiment (step S1 to S11).

By contrast, if the wiper 107 is being operated (step S31: YES), it is determined whether the current operating position of the wiper 107 is within a given regulated area (step S32). The regulated area can be set as an area where waterdrops adhering on the wiper 107 may adhere on the lighting area of the detection-use light on the windshield 105. Specifically, the regulated area is set as a given area including the lighting area of the detection-use light where the wiper 107 moves over, and the raindrop detection process is suspended from a time point when the wiper 107 is to move into the lighting area of the detection-use light and a time point when the wiper 107 moves out the lighting area of the detection-use light.

For example, the current operating position of the wiper 107 can be identified by using the detection processor 102A of the image analyzer 102, and the wiper controller 106, in which the detection processor 102A of the image analyzer 102 can acquire information of wiper position for identifying the current operating position of the wiper 107 from the wiper controller 106. Further, the information identifying the wiper position may be position information of the current operating position of the wiper 107, or a wiper drive signal output most recently from the wiper controller 106. The detection processor 102A of the image analyzer 102 can identify the current operating position of the wiper 107 based on an elapsed time from the output timing of the wiper drive signal and a pre-set wiper speed.

If the detection processor 102A of the image analyzer 102 determines that the current operating position of the wiper 107 is not within the given regulated area (step S32: NO), the raindrop detection process is performed same as the first example embodiment (steps S1 to S11). By contrast, if the detection processor 102A of the image analyzer 102 determines that the current operating position of the wiper 107 is within the given regulated area (step S32: YES), the raindrop detection process is suspended or stopped. With this configuration, the raindrop detection process is not performed as long as the current operating position of the wiper 107 is within the given regulated area.

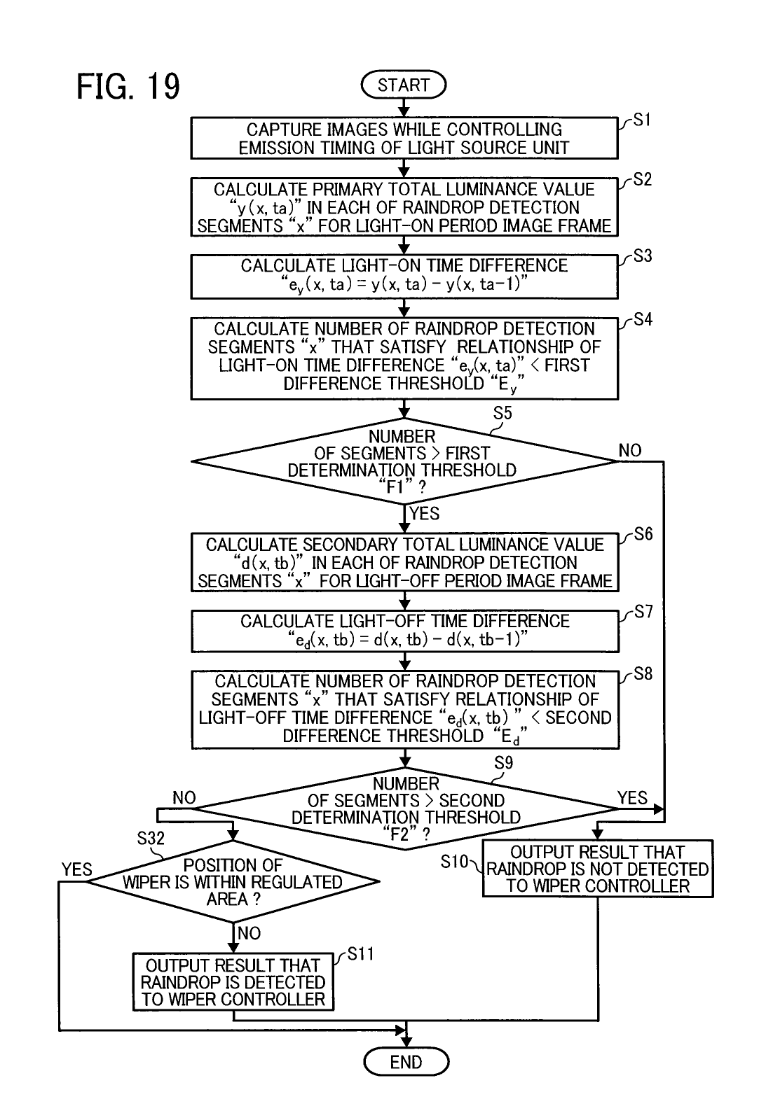

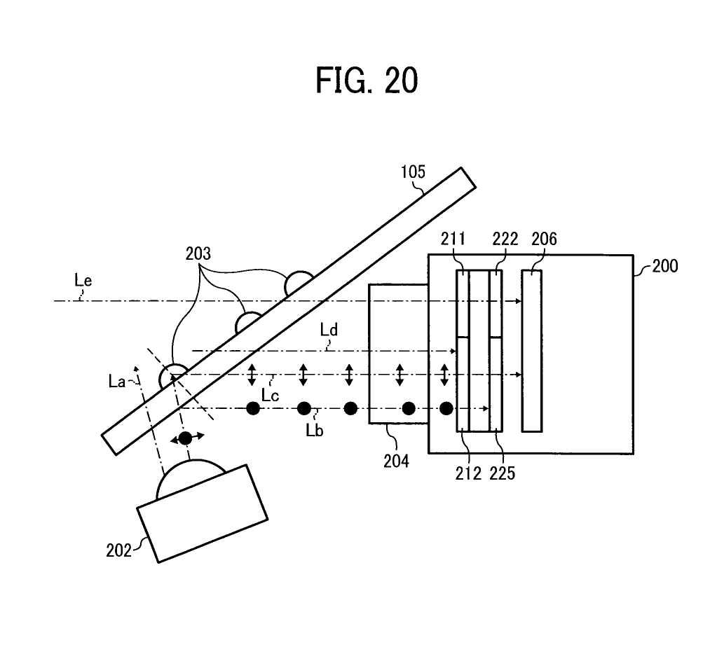

As to the variant example 2, step S32 determining whether the current operating position of the wiper 107 is within the given regulated area is performed at first in the raindrop detection process, but not limited hereto. For example, step S32 can be performed at any timing if an output of the wiper drive signal from the wiper controller 106 can be stopped when the current operating position of the wiper 107 is within the given regulated area. Therefore, for example, as illustrated in FIG. 19, when the number of the raindrop detection segments “x” having the light-ON time difference “ey(x, ta)” smaller than the first difference threshold “Ey” exceeds the first determination threshold “F1” (step S5: YES) and the number of the raindrop detection segments “x” having the light-OFF time difference “ed(x, tb)” smaller than the second difference threshold “Ed” becomes the second determination threshold “F2” or less (step S9: NO), step S32 determining whether the current operating position of the wiper 107 is within the given regulated area can be performed.

### Variant Example 3

A description is given of another variant example of the first example embodiment (hereinafter, variant example 3). As to the above described first example embodiment and variant examples 1 and 2, the light-ON time difference “ey(x, ta)” is used as an example of the lighting-period changed quantity. However, the lighting-period changed quantity is not limited to the light-ON time difference ey(x, ta) as long as the lighting-period changed quantity indicates a change of the lighting-period received light quantity over the time. The lighting-period changed quantity can use any indexes or indicators that can quantify a change level of the currently calculated primary total luminance value “y(x, ta)” and the most recently calculated primary total luminance value “y(x, ta−1)” for each of the raindrop detection segments “x” for the light-ON period image frames 2, 4, 6, 8, 10, 12 (ta=1, 2, 3, 4, 5, 6). As to the variant example 3, a ratio of the currently calculated primary total luminance value “y(x, ta) and the most recently calculated primary total luminance value “y(x, ta−1) for each of the raindrop detection segments “x” can be defined as a lighting-ON period ratio “ry(x, ta)=y(x, ta)/y(x, ta−1),” and then one (1) is subtracted from the lighting-ON period ratio “ry(x, ta)=y(x, ta)/y(x, ta−1)” to define the lighting-ON period change ratio “py(x, ta)=ry(x, ta)−1” as another example of the lighting-period changed quantity.

Further, the lighting-ON period change ratio “py (x, ta)” can be transformed to “py(x, ta)={y(x, ta)−y(x, ta−1)}/y(x, ta−1).” Therefore, the lighting-ON period change ratio “py (x, ta)” can be set by dividing the light-ON time difference “ey(x, ta)” used for the above described first example embodiment and variant examples 1 and 2 with the most recently calculated primary total luminance value “y(x, ta−1).”

Further, as to the above described first example embodiment and variant examples 1 and 2, the light-OFF time difference “ed(x, tb)” is used as an example of the non-lighting-period changed quantity. However, the non-lighting-period changed quantity is not limited to the light-OFF time difference “ed(x, tb)” as long as the non-lighting-period changed quantity indicates a change of the non-lighting-period received light quantity over the time. Similar to the lighting-period changed quantity, the non-lighting-period changed quantity can use any indexes or indicators that can quantify the change level of the currently calculated secondary total luminance value “d(x, tb)” and the most recently calculated secondary total luminance value “d(x, tb−1)” for each of the raindrop detection segments “x” for the light-OFF period image frames 1, 3, 5, 7, 9, 11 (tb=1, 2, 3, 4, 5, 6). As to the variant example 3, a ratio of the currently calculated secondary total luminance value “d(x, tb)” and the most recently calculated secondary total luminance value “d(x, tb−1)” for each of the raindrop detection segments “x” can be defined as the lighting-OFF period ratio “rd(x, tb)=d(x, tb)/d(x, tb−1),” and then one (1) is subtracted from the lighting-OFF period ratio “rd(x, tb)=d(x, tb)/d(x, tb−1)” to define a lighting-OFF period change ratio “pd(x, tb)=rd(x, tb)−1” as another example of the non-lighting-period changed quantity.

Further, the lighting-OFF period change ratio “pd(x, tb)” can be transformed to “pd(x, tb)={d(x, tb)−d(x, tb−1)}/d(x, tb−1).” Therefore, the lighting-OFF period change ratio “pd(x, tb)” can be set by dividing the light-OFF time difference “ed(x, tb)” used for the above described first example embodiment and variant examples 1 and 2 with the most recently calculated secondary total luminance value “d(x, tb−1).”

Similar to the light-ON time difference “ey(x, ta)” used for the above described first example embodiment and variant examples 1 and 2, the lighting-ON period change ratio “py (x, ta)” used for the variant example 3 becomes a negative value when the total luminance value of each of the raindrop detection segments “x” decreases due to the raindrop adhesion, and the lighting-ON period change ratio “py (x, ta)” used for the variant example 3 becomes a positive value when the total luminance value of each of the raindrop detection segments “x” increases due to the entering of ambient light. Therefore, similar to the above described first example embodiment and variant examples 1 and 2, the fluctuation of raindrop adhering amount can be detected for the variant example 3.

Further, similar to the light-OFF time difference “ed(x, tb)” used for the above described first example embodiment and variant examples 1 and 2, the lighting-OFF period change ratio “pd(x, tb)” used for the variant example 3 becomes a negative value when the total luminance value of each of the raindrop detection segments “x” decreases due to the automatic correction process, and the lighting-OFF period change ratio “pd(x, tb)” used for the variant example 3 becomes a positive value when the total luminance value of each of the raindrop detection segments “x” increases due to the entering of ambient light. Therefore, similar to the above described first example embodiment and variant examples 1 and 2, the entering of ambient light and the erroneous operation caused by the automatic correction process can be detected.

As to the above described first example embodiment and variant examples 1 and 2, the light-ON time difference “ey(x, ta)” is used as the lighting-period changed quantity, in which the luminance value of the light-ON period image frames 2, 4, 6, 8, 10, 12 (ta=1, 2, 3, 4, 5, 6) is not considered. In this case, for example, if the luminance value of the light source unit 202 decreases and/or sensitivity of the light receiving element such as the image sensor 206 decreases, the fluctuation of the total luminance value due to the raindrop adhesion may become smaller even if the raindrop adhering condition on the windshield 105 is being the same condition. If this situation occurs, one condition that has been satisfying the detection condition may not satisfy the raindrop detection condition anymore, which may not be preferable. Further, if the fluctuation of the total luminance value due to the raindrop adhesion becomes greater, one condition that has not been satisfying the detection condition may satisfy the raindrop detection condition even if the raindrop adhering condition on the windshield 105 is being the same condition, which may not be preferable.

As to the variant example 3, the lighting-ON period change ratio “py (x, ta)” is used as an index or indicator of the lighting-period changed quantity, in which the light-ON time difference “ey(x, ta)” used for the above described first example embodiment and variant examples 1 and 2 can be normalized by using the luminance value of the light-ON period image frames, with which the above described problem can be reduced, and further prevented. Further, as to the variant example 3, the most recently calculated primary total luminance value “y(x, ta−1)” is used for normalizing, but not limited hereto. For example, the currently calculated primary total luminance value “y(x, ta)” can be used for the normalizing, or an average value of the primary total luminance value “y” for a plurality of light-ON period image frames can be used for the normalizing.

Further, when the light-OFF time difference “ed(x, tb)” is used as the non-lighting-period changed quantity as disclosed in the above described first example embodiment and variant examples 1 and 2, the luminance value of the light-OFF period image frames 1, 3, 5, 7, 9, 11 (tb=1, 2, 3, 4, 5, 6) is not considered. In this case, for example, if the sensitivity of the light receiving element such as the image sensor 206 fluctuates, the fluctuation of the total luminance value becomes smaller or greater even if the entering of the ambient light is being the same condition. If this situation occurs, the light-OFF time difference “ed(x, tb)” may not indicate the effect of ambient light factor correctly.

As to the variant example 3, the lighting-OFF period change ratio “pd(x, tb)” is used as an index or indicator of the non-lighting-period changed quantity, in which the light-OFF time difference “ed(x, tb)” used for the above described first example embodiment and variant examples 1 and 2 can be normalized by using the luminance value of the light-OFF period image frames, with which the lighting-OFF period change ratio “pd(x, tb)” can indicate the ambient light factor correctly even if the sensitivity of the light receiving element such as the image sensor 206 fluctuates, with which the above described problem can be reduced, and further prevented. As to the variant example 3, the most recently calculated secondary total luminance value “d(x, tb−1) is used for normalizing, but not limited hereto. For example, the currently calculated secondary total luminance value “d(x, tb)” can be used for the normalizing, or an average value of the secondary total luminance value “d” for a plurality of light-OFF period image frames can be used for the normalizing.

The lighting-period changed quantity can use an output value of any functions using the luminance value of the plurality of light-ON period image frames as an input such as the light-ON time difference “ey(x, ta)” of the above described first example embodiment and variant examples 1 and 2, and the lighting-ON period change ratio “py (x, ta)” of the variant example 3. Further, the non-lighting-period changed quantity can use an output value of any functions using the luminance value of the plurality of light-OFF period image frames as an input such as the light-OFF time difference “ed(x, tb)” of the above described first example embodiment and variant examples 1 and 2, and the lighting-OFF period change ratio “pd(x, tb)” of the variant example 3.

The functions for computing the lighting-period changed quantity and the non-lighting-period changed quantity can be the same or different. If the same function is used, for example, the lighting-ON period ratio “ry(x, ta)” can be used as the lighting-period changed quantity, and the lighting-OFF period ratio “rd(x, tb)” can be used as the non-lighting-period changed quantity. Further, if the different functions are used, for example, the light-ON time difference “ey(x, ta)” can be used as the lighting-period changed quantity while the lighting-OFF period change ratio “pd(x, tb)” can be used as the non-lighting-period changed quantity, or the lighting-ON period change ratio “py(x, ta)” can be used as the lighting-period changed quantity while the light-OFF time difference “ed(x, tb)” can be used as the non-lighting-period changed quantity.

### Second Example Embodiment

A description is given of the object detection apparatus applied to an adhered substance detection apparatus used for the control system to control the vehicle-installed devices as another example embodiment (hereinafter, second example embodiment). As to the above described first example embodiment, the reflective deflection prism 230 is used, in which light used for the detection passes through the outer face of the windshield 105 where the raindrop adheres while the light used for the detection reflecting at the outer face of the windshield 105 at the non-adhering portion of raindrop is received by the image sensor 206. By contrast, as to the second example embodiment, the light used for the detection passes through the outer face of the windshield 105 at the non-adhering portion of raindrop while the light used for the detection passing through the outer face of the windshield 105 at the adhering portion of raindrop and reflecting in the raindrop can be received by the image sensor 206 as illustrated in FIG. 20.

In the configuration of FIG. 20, the light used for the detection emitted from the light source unit 202 directly enters the inner face of the windshield 105, but the light used for the detection can enter the inner face of the windshield 105 via a light path changing member such as a mirror. In the configuration of FIG. 20, the light source such as the light source unit 202 can be mounted on the sensor board 207 same as the above described first example embodiment.

### (Light Beam La)

Light beam La of FIG. 20 is a light used for the detection (detection-use light) emitted from the light source 202 and then passes through the windshield 105. When the raindrop 203 does not adhere on the outer face of the windshield 105, the light emitting from the light source 202 and forwarding to the windshield 105 passes through the windshield 105, and goes out of the vehicle 100 as the light beam La of FIG. 20. The light beam La may enter human eyes, which may cause injury. Therefore, the light source 202 may preferably employ a light source having a wavelength and light quantity that may not cause eyes injury even if the light enters human eyes.

### (Light Beam Lb)

Light beam Lb of FIG. 20 is a light (detection-use light) emitted from the light source 202 and reflected regularly on the inner face of the windshield 105 and then entering the image capture device 200. As such, some of the light emitted from the light source 202 and going toward the windshield 105 regularly reflects on the inner face of the windshield 105. Such regular reflection light such as light beam Lb (FIG. 20) has a polarization light component. The polarization light component of light beam Lb is mostly S-polarized light component (or horizontal polarized light component S), which oscillates in a direction perpendicular to a light incidence plane (or oscillates in a direction perpendicular to a sheet of FIG. 20). The light beam Lb (i.e., regular reflection light) reflected regularly on the inner face of the windshield 105 does not fluctuate whether the raindrop 203 adheres or not on the outer face of the windshield 105, and the light beam Lb is not necessary for the raindrop detection. Further, the light beam Lb becomes ambient light that degrades the detection precision of the raindrop detection. In the second example embodiment, the light beam Lb (horizontal polarized light component S) is cut by a polarized light filter 225 disposed for the optical filter 205. Therefore, deterioration of the precision of raindrop detection due to the light beam Lb can be reduced, suppressed, or prevented.

### (Light Beam Lc)

Light beam Lc of FIG. 20 is a light (detection-use light), emitted from the light source 202 and passing through the inner face of the windshield 105, reflected at a raindrop adhered on the outer face of the windshield 105, and then entering the image capture device 200. Some of the light emitted from the light source 202 and going toward the windshield 105 passes through the inner face of the windshield 105 as passing light. Such passing light includes the perpendicular polarized light component P greater than the horizontal polarized light component S. If the raindrop 203 adheres on the outer face of the windshield 105, the passing light, which has passed through the inner face of the windshield 105, does not go out of the windshield 105, different from the light beam La, but the passing light reflects inside the raindrop for multiple times, and passes through in the windshield 105 again toward the image capture device 200, and enters the image capture device 200. As to the optical filter 205 of the image capture device 200, the infrared transmittance-filter area 212 disposed for the front-end filter 210 is configured to pass through the light having a wavelength of emission light of the light source 202, which is infrared light. Therefore, the light beam Lc passes through the infrared transmittance-filter area 212. Further, the polarized light filter 225 employs the wire grid structure by forming the long side direction of metal wire into a shape to pass through the perpendicular polarized light component P, by which the light beam Lc can pass through the polarized light filter 225. Therefore, the light beam Lc reaches the image sensors 206, and the raindrop detection can be performed using the light received by the image sensor 206.

### (Light Beam Ld)

Light beam Ld in FIG. 20 is a light, coming from the outside of the windshield 105 and passing through the windshield 105, and then entering the image capture device 200. The light beam Ld may become ambient light when to perform the raindrop detection, but most of light component having a given wavelength included in the light beam Ld can be cut by the infrared transmittance-filter area 212 disposed for the front-end filter 210 of the optical filter 205 of the second example embodiment. Therefore, deterioration of the precision of raindrop detection due to the light beam Ld can be reduced, suppressed, or prevented.

### (Light Beam Le)

Light beam Le of FIG. 20 is light, coming from the outside of the windshield 105 and passing through the windshield 105, and then entering the image capture device 200. The infrared cut-filter area 211, disposed for the front-end filter 210 of the optical filter 205, cuts infrared light included in the light beam Le, and thereby only visible light component of the light beam Le can be captured and received by the image sensor 206 as captured image data. Such captured image data can be used to detect the headlight of the incoming vehicle, the tail lamp of the front-running vehicle (ahead vehicle), and the lane (e.g., white line).

As to the second example embodiment, the detection-use light refracted and reflected by the raindrop enters the image sensor 206. Therefore, different from the above described first example embodiment, the non-adhering portion of the outer face of the windshield 105 where raindrops does not adhere becomes a lower luminance image portion (lower pixel value) on the raindrop detection image area 214 of the captured image data while the adhering portion of the outer face of the windshield 105 where raindrops adhere becomes a higher luminance image portion (higher pixel value) on the raindrop detection image area 214 of the captured image data. The second example embodiment can perform the processing similar to the above described first example embodiment by setting one or more thresholds in view of this difference. Further, the above described various variant examples can be also applied to the second example embodiment.

Specifically, as to the second example embodiment, the total luminance value becomes greater when the raindrop adheres, in which the light-ON time difference “ey(x, ta)=y(x, ta)−y(x, ta−1)” becomes a positive value, and thereby the first difference threshold “Ey” is set with a positive value. In this case, at step S4, the number of the raindrop detection segments “x” having the light-ON time difference “ey(x, ta)” equal to the first difference threshold “Ey” or more is calculated for the raindrop detection segments “x.”

Further, the changed quantity (lighting-period changed quantity) of the primary total luminance value “y(x, ta)” of each of the raindrop detection segments “x” can be defined by subtracting the primary total luminance value “y(x, ta)” of the currently calculated light-ON period image frame from the primary total luminance value “y(x, ta−1)” of the most recently calculated light-ON period image frame. In a case of the second example embodiment that the total luminance value becomes greater when the raindrop adheres, the light-ON time difference “ey(x, ta)=y(x, ta−1)−y(x, ta)” becomes a negative value when the raindrop adheres, and thereby the first difference threshold “Ey” is set with a negative value. In this case, at step S4, the number of the raindrop detection segments “x” having the light-ON time difference “ey(x, ta)” smaller than the first difference threshold “Ey” is calculated for the raindrop detection segments “x.”

Further, the changed quantity (lighting-period changed quantity) of the primary total luminance value “y(x, ta)” of each of the raindrop detection segments “x” can be defined by an absolute value of a difference of the primary total luminance value “y(x, ta−1)” of the most recently calculated light-ON period image frame and the primary total luminance value “y(x, ta)” of the currently calculated light-ON period image frame. In a case of the second example embodiment that the total luminance value becomes greater when the raindrop adheres, the light-ON time difference “ey(x, ta)”=|y(x, ta)−y(x, ta−1)|” becomes a positive value when the raindrop adheres, and thereby the first difference threshold “Ey” is set with a positive value. In this case, at step S4, the number of the raindrop detection segments “x” having the light-ON time difference “ey(x, ta)” equal to the first difference threshold “Ey” or more is calculated for the raindrop detection segments “x.”

In a case of the second example embodiment that the total luminance value becomes greater when the raindrop adheres, the ambient-light-related variable factor mistakenly detected as the raindrop-related variable factor occurs when the light quantity of ambient light increases. If the light-OFF time difference “ed(x, tb)=d(x, tb)−d(x, tb−1)” is used as the changed quantity (non-lighting-period changed quantity) of the secondary total luminance value “d(x, tb)” for each of the raindrop detection segments “x,” the light-OFF time difference “ed(x, tb)” becomes a positive value, and thereby the second difference threshold “Ed” is set with a positive value. In this case, at step S8, the number of the raindrop detection segments “x” having the light-OFF time difference “ed(x, tb)” equal to the second difference threshold “Ed” or more is calculated for the raindrop detection segments “x.”

Further, the changed quantity (non-lighting-period changed quantity) of the secondary total luminance value “d(x, tb)” of each of the raindrop detection segments “x” can be defined by subtracting the secondary total luminance value “d(x, tb)” of the currently calculated light-OFF period image frame from the secondary total luminance value “d(x, tb−1)” of the most recently calculated light-OFF period image frame. In a case of the second example embodiment that the total luminance value becomes greater when the raindrop adheres, the ambient-light-related variable factor mistakenly detected as the raindrop-related variable factor occurs when the light quantity of ambient light increases, in which the light-OFF time difference “ed(x, tb)=d(x, tb−1)−d(x, tb)” becomes a negative value, and thereby the second difference threshold “Ed” is set with a negative value. In this case, at step S8, the number of the raindrop detection segments “x” having the light-OFF time difference “ed(x, tb)” smaller than the second difference threshold “Ed” is calculated for the raindrop detection segments “x.”

Further, the changed quantity (non-lighting-period changed quantity) of the secondary total luminance value “d(x, tb)” of each of the raindrop detection segments “x” can be defined an absolute value of a difference of the secondary total luminance value “d(x, tb−1)” of the most recently calculated light-OFF period image frame and the secondary total luminance value “d(x, tb)” of the currently calculated light-OFF period image frame. In a case of the second example embodiment that the total luminance value becomes greater when the raindrop adheres, even if the ambient-light-related variable factor mistakenly detected as the raindrop-related variable factor occurs when the light quantity of ambient light increases, since the light-OFF time difference “ed(x, tb)=|d(x, tb)−d(x, tb−1)|” becomes a positive value, the second difference threshold “Ed” can be set with a positive value. In this case, at step S8, the number of the raindrop detection segments “x” having the light-OFF time difference “ed(x, tb)” equal to the second difference threshold “Ed” or more is calculated for of the raindrop detection segments “x.”

As to the above described first example embodiment and second example embodiment including variant examples 1 to 3, the light receiver employs, for example, an image sensor, and the light-ON time difference “ey(x, ta)” and the light-OFF time difference “ed(x, tb)” acquired from two dimensional data (i.e., captured image data) can be used as the lighting-period changed quantity and the non-lighting-period changed quantity to determine the raindrop detection condition, but not limited hereto. For example, a sensor having a plurality of light receiving elements such as photoelectric conversion elements arranged along an one-directional row can be used to obtain one dimensional data to calculate the lighting-period changed quantity and the non-lighting-period changed quantity for determining the raindrop detection condition. Further, an output value (received light quantity) obtained from one of the light receiving elements (photoelectric conversion element) can be used to calculate the lighting-period changed quantity and the non-lighting-period changed quantity for determining the raindrop detection condition.

Further, the output value (received light quantity) obtained from every each one of the light receiving elements (photoelectric conversion elements) can be used to calculate the lighting-period changed quantity and the non-lighting-period changed quantity for determining the raindrop detection condition. Further, the output value (received light quantity) obtained from the plurality of the light receiving elements (photoelectric conversion elements) can be synthesized to calculate the lighting-period changed quantity and the non-lighting-period changed quantity for determining the raindrop detection condition. Specifically, two dimensional data obtained by the light receiver can be accumulated in a given range as a value to calculate the lighting-period changed quantity and the non-lighting-period changed quantity, two dimensional data obtained by the light receiver can be accumulated into the vertical direction or the horizontal direction as a value to calculate the lighting-period changed quantity and the non-lighting-period changed quantity, or the entire of one dimensional data obtained by the light receiver can be accumulated as a value to calculate the lighting-period changed quantity and the non-lighting-period changed quantity. As above described, when the output value (received light quantity) obtained by the plurality of the light receiving elements are synthesized to calculate the lighting-period changed quantity and the non-lighting-period changed quantity, the noise effect occurred at each of the light receiving elements can be reduced, and computing load and storage capacity can be reduced by decreasing the number of data.

Further, as to the above described first example embodiment and second example embodiment including variant examples 1 to 3, the raindrop detection image area 214 and the vehicle detection image area 213 are captured as the same time, but the raindrop detection image area 214 alone can be captured by using a raindrop detection specific apparatus. Further, as to the above described first example embodiment and second example embodiment including variant examples 1 to 3, the raindrop adhered on the windshield 105 of the vehicle 100 is detected as the detection-target object, but the object detection apparatus is not limited hereto, and can be applied various fields. For example, the raindrop adhering on the optical transparency material such as a lens and a cover of a monitoring camera or building window can be detected as the detection-target object. Further, the optical transparency material can be made of transparent or semi-transparent material such as glass, plastic, and the like. Further, the detection-target object is not limited to raindrops, and further the detection-target object is not limited to objects or substances adhering on the optical transparency material such as the windshield 105. Further, the result of the detection process can be used for controlling operations of the wiper 107 and others. For example, the result of the detection process can be used for a system controlling operations of a remover of raindrop that removes raindrops by using an air flow or heating, or can be used for other systems controlling operations of other apparatuses.

The above described example embodiments can be configured as follows.

### (Configuration A)

The above described object detection apparatus includes the light source such as the light source unit 202 to emit detection-use light, the light receiver such as the image sensor 206 to receive first light having lighting-period received light quantity used for detecting a detection-target object existing within a lighting area of the detection-use light when the light source emits the detection-use light, and second light having non-lighting-period received light quantity when the light source does not emit the detection-use light, and the detection processor such as the detection processor 102A to perform a detection process to determine whether a given condition used for detecting an increase or decrease of the detection-target object within the lighting area is satisfied based on lighting-period changed quantity such as the light-ON time difference “ey(x, ta)” indicating a change of the lighting-period received light quantity over the time, and non-lighting-period changed quantity such as the light-OFF time difference “ed(x, tb)” indicating a change of the non-lighting-period received light quantity over the time.

As to the configuration A, in the detection process determining whether the given condition used for detecting the increase or decrease of the detection-target object within the lighting area of the detection-use light is satisfied, two parameters such as the lighting-period changed quantity and the non-lighting-period changed quantity can be used. The lighting-period changed quantity indicates the change of the lighting-period received light quantity received by the light receiver over the time when the light source emits the detection-use light. Therefore, if the lighting-period received light quantity changes due to emerging or disappearance of the detection-target object within the lighting area, the lighting-period changed quantity changes, with which the increase or decrease of the detection-target object within the lighting area can be detected based on the lighting-period changed quantity. The increase or decrease of the detection-target object within the lighting area may mean that a new detection-target object emerges within the lighting area or the already-existing detection-target object disappears from the lighting area. Therefore, various controls such as wiper drive control can be performed by using the detection process result of the object detection apparatus similar to conventional technologies.

Factors that can change the lighting-period changed quantity include a factor of increase or decrease of the detection-target object within the lighting area, and other factors such as a timewise change of the light quantity of ambient light entering the light receiver, and a factor other than the change of the light quantity of ambient light over the time. As above described, most of the factors other than the timewise change of the light quantity of ambient light over the time may be related to temperature change and aging, and the other factor changes very slowly.

Therefore, if the change monitoring period used for monitoring the change of the lighting-period received light quantity over the time, which is used for calculating the lighting-period changed quantity, is set shorter than a time period that the light quantity related to the factor other than ambient light changes significantly over the time, the main factor that changes the lighting-period changed quantity can be assumed as the timewise change of the light quantity of ambient light entering the light receiver except the factor of increase or decrease of the detection-target object.

The change of the lighting-period changed quantity caused by the timewise change of the light quantity of ambient light entering the light receiver can be determined based on the non-lighting-period changed quantity indicating a change of the non-lighting-period received light quantity received by the light receiver over the time when the light source does not emit the detection-use light. Specifically, the main factor that changes the non-lighting-period changed quantity includes two factors such as the factor of timewise change of the light quantity of ambient light entering the light receiver over the time, and the factor other than the timewise change of the light quantity of ambient light over the time. If the change monitoring period used for monitoring the change of the non-lighting-period received light quantity over the time, which is used for calculating the non-lighting-period changed quantity, is set shorter similar to the case of the lighting-period changed quantity as above described, the main factor that changes the non-lighting-period changed quantity can be assumed as the timewise change of the light quantity of ambient light entering the light receiver in the same way. With this processing, the timewise change of the light quantity of ambient light over the time can be determined correctly based on the non-lighting-period changed quantity without the effect of the factor other than the timewise change of the light quantity of ambient light over the time. Therefore, it can determine whether the factor of timewise change of the light quantity of ambient light is included when the lighting-period changed quantity changes by using the non-lighting-period changed quantity.

As above described, it can determine whether the factor of timewise change of the light quantity of ambient light is included by using the non-lighting-period changed quantity. Therefore, by performing suitable processing to the factor of timewise change of the light quantity of ambient light, the detection process for detecting the increase or decrease of the detection-target object can be performed effectively and correctly based on the lighting-period changed quantity. Specifically, for example, if it is determined that the factor of timewise change of the light quantity of ambient light is included based on the non-lighting-period changed quantity when the lighting-period changed quantity is changing, it can be determined that the increase or decrease of the detection-target object is not detected from the calculated lighting-period changed quantity, with which false detection or miss detection of the increase or decrease of the detection-target object can be reduced, in particular prevented.

By contrast, if it is determined that the factor of timewise change of the light quantity of ambient light is not included based on the non-lighting-period changed quantity when the lighting-period changed quantity is changing, the factor that changes the lighting-period changed quantity can be assumed as the factor of the increase or decrease of the detection-target object alone, and the increase or decrease of the detection-target object can be detected correctly from the calculated lighting-period changed quantity.

### (Configuration B)

As to the configuration A, the first condition such as steps S4 and S5 is used to determine whether the increase or decrease of the detection-target object is detected within the lighting area using the lighting-period changed quantity without using the non-lighting-period changed quantity, and the second condition such as steps S8 and S9 is used to determine whether a determination result of the first condition is used as a result of the detection process by using the non-lighting-period changed quantity.

If the timewise change of differential information obtained by subtracting the non-lighting-period received light quantity from the lighting-period received light quantity is used to remove the ambient-light-related component from the lighting-period received light quantity instead of the lighting-period changed quantity alone when determining the first condition, the increase or decrease of the detection-target object may not be detected correctly. This may be caused as follows.

Since the non-lighting-period received light quantity may not exactly indicate the ambient-light-related component in the lighting-period received light quantity, the differential information may still include a tiny level of ambient-light-related component, or a part of the required received light quantity component indicating the detection-target object may be subtracted, with which the differential information may deviate from the required received light quantity component indicating the detection-target object correctly. If the timewise change of differential information, deviated from the required received light quantity that can indicate the detection-target object correctly, is used, the deviation may be increased. Then, if the increase or decrease of the detection-target object is to be detected based on the timewise change of differential information deviated from the required received light quantity, the false detection or miss detection of the increase or decrease of the detection-target object may more likely occur.

As to the configuration B, the parameter used for determining the increase or decrease of the detection-target object based on the first condition uses the lighting-period changed quantity without using the non-lighting-period changed quantity, in which the above described timewise change of the differential information is not used. Therefore, if a determination result of the first condition is determined as a result of the detection process based on the second condition (e.g., if it is determined that the factor of the timewise change of the light quantity of ambient light is not included in the change of the lighting-period changed quantity based on the non-lighting-period changed quantity), the false detection or miss detection of the increase or decrease of the detection-target object caused by using the timewise change of the differential information does not occur to the result of the detection process.

Further, if the lighting-period changed quantity is used as a parameter for determining the first condition, the increase or decrease of the detection-target object can be detected correctly as follows. Specifically, the lighting-period received light quantity used for calculating the lighting-period changed quantity may include the received light quantity of ambient light, and it is difficult to correctly determine the amount level of the received light quantity of ambient light included in the lighting-period changed quantity. However, by using the differential value of the lighting-period received light quantity detected at two different time points as the lighting-period changed quantity, the timewise change of the light quantity of ambient light does not included substantially (i.e., the factor of timewise change of the light quantity of ambient light is not included when the lighting-period changed quantity is changing), the received light quantity of ambient light may not affect the detection precision when the increase or decrease of the detection-target object is detected from the lighting-period changed quantity. Therefore, the increase or decrease of the detection-target object can be detected correctly based on the lighting-period changed quantity even if the amount level of the received light quantity of ambient light included in the lighting-period received light quantity is not detected correctly.

### (Configuration C)

As to the configuration B, the first condition includes a condition that the lighting-period changed quantity is a first threshold or more, and the second condition includes a condition that the non-lighting-period changed quantity is smaller than a second threshold.

When the non-lighting-period changed quantity is smaller than the second threshold, it can be determined that the timewise change of the light quantity of ambient light is little or none. Therefore, the lighting-period changed quantity under this condition can be determined whether the detection-target object exists or not without being affected by the timewise change of the light quantity of ambient light. Therefore, if the non-lighting-period changed quantity is smaller than second threshold, and the lighting-period changed quantity is the first threshold or more, it can be determined that the detection-target object increase or decreases actually.

As to the configuration C, as above described, the parameters such as the light-ON time difference “ey(x, ta)” and the light-OFF time difference “ed(x, tb)” that become positive or negative values depending on the increase or decrease of detection-target object and/or the increase or decrease of light quantity of ambient light can be used as the lighting-period changed quantity and the non-lighting-period changed quantity.

In this configuration, the positive or negative of the thresholds such as the first threshold used for determining whether the lighting-period changed quantity is a given value or more and/or the second threshold used for determining whether the non-lighting-period changed quantity becomes smaller than a given value, and the magnitude correlation of the thresholds and the parameters can be set as follows. Specifically, the thresholds for parameters can be set variably in view of the above described cases such as the lighting-period changed quantity is decreased when the detection-target object is increased (first example embodiment), the lighting-period changed quantity is increased when the detection-target object is increased (second example embodiment), and also the computation of differential values such as a differential value subtracting past lighting-period received light quantity from current lighting-period received light quantity, or a differential value subtracting current lighting-period received light quantity from past lighting-period received light quantity. As to the configuration C, it can be determined whether the lighting-period changed quantity becomes greater or smaller, or the non-lighting-period changed quantity becomes greater or smaller.

### (Configuration D)

As to the configuration A, when the detection processor determines whether the given condition is satisfied, the detection processor does not use the lighting-period changed quantity when the non-lighting-period changed quantity is the second threshold or more.

When the non-lighting-period changed quantity is the second threshold or more, the timewise change of the light quantity of ambient light becomes greater, and thereby it can be assumed that the lighting-period changed quantity under this condition may be affected by the timewise change of the light quantity of ambient light. As to configuration D, the lighting-period changed quantity affected by the change of light quantity of ambient light is not used for determining whether the given detection condition is satisfied. Therefore, the false detection or miss detection of the increase or decrease of the detection-target object caused by the timewise change of the light quantity of ambient light can be evaded.

### (Configuration E)

As to any one of the configurations A to D, when the detection processor obtains results of a plurality of detection processes performed within a given condition changeable period, the detection processor changes the given condition to be used for a detection process to be performed after the given condition changeable period based on the results of the plurality of detection processes.

For example, when a process result not detecting the increase or decrease of the detection-target object is generated for a plurality of detection processes within the given condition changeable period, it can be assumed that a situation not detecting the increase or decrease of the detection-target object may continue with a higher probability. If this situation continues, the false detection of the increase or decrease of the detection-target object may cause problems compared to the miss detection of the increase or decrease of the detection-target object. As to configuration E, when the process result not detecting the increase or decrease of the detection-target object is generated for the plurality of detection processes within the given condition changeable period, the given condition can be changed, for example, to decrease the detection sensitivity of the increase or decrease of the detection-target object. With employing this configuration, when the process result not detecting the increase or decrease of the detection-target object continues, the false detection of the increase or decrease of the detection-target object can be suppressed, and thereby the associated problem can be suppressed effectively.

By contrast, for example, when a process result detecting the increase or decrease of the detection-target object is generated for a plurality of the detection processes within the given condition changeable period, it can be assumed that a situation detecting the increase or decrease of the detection-target object may continue with a higher probability. If this situation continues, the miss detection of the increase or decrease of the detection-target object may cause problems compared to the false detection of the increase or decrease of the detection-target object. As to configuration E, when the process result detecting the increase or decrease of the detection-target object is generated for the plurality of detection processes within the given condition changeable period, the given condition can be changed, for example, to increase the detection sensitivity of the increase or decrease of the detection-target object. With employing this configuration, when the process result detecting the increase or decrease of the detection-target object continues, the miss detection of the increase or decrease of the detection-target object can be suppressed, and thereby the associated problem can be suppressed effectively.

### (Configuration F)

As to any one of the configurations A to E, when the detection processor obtains results of a plurality of detection processes performed within a given condition changeable period, the detection processor changes a duration of a change monitoring period for monitoring the change of the lighting-period received light quantity over the time to be used for a detection process to be performed after the given condition changeable period based on the results of the plurality of detection processes. By changing the duration of the change monitoring period used for monitoring the timewise change of the lighting-period received light quantity used for calculating the lighting-period changed quantity, the detection sensitivity of the detection-target object can be increased or decreased. Therefore, similar to the above described configuration E, when the process result not detecting the increase or decrease of the detection-target object continues, the false detection of the increase or decrease of the detection-target object can be suppressed, and when the process result detecting the increase or decrease of the detection-target object continues, the miss detection of the increase or decrease of the detection-target object can be suppressed.

### (Configuration G)

As to any one of the configurations A to F, the detection-target object is an object or substance such as raindrops adhereable on the optical transparency material such as the windshield 105 lighted by the detection-use light of the light source. With employing this configuration, the object or substance adhering on the optical transparency material can be detected correctly.

### (Configuration H)

As to any one of the configurations A to G, the detection processor determines whether the detection process is to be performed depending on an operation timing of the removing unit such as the wiper 107 capable of intermittently removing the detection-target object existing within the lighting area. With employing this configuration, as above described with the variant example 2, even when the object other than the detection-target object (non-detection-target object) adhering on the removing unit enters the lighting area of the detection-use light due to an operation of the removing unit, the false detection or miss detection of the increase of the detection-target object due to the non-detection-target object can be evaded.

### (Configuration I)

As to any one of the configurations A to H, the detection processor uses the light-ON time difference ey(x, ta) as the lighting-period changed quantity defined by a differential value between the lighting-period received light quantity received by the light receiver at one time point and the lighting-period received light quantity received by the light receiver at another time point. With employing this configuration, the lighting-period changed quantity can be acquired easily.

### (Configuration J)

As to any one of the configurations A to H, the detection processor uses the lighting-ON period change ratio “py (x, ta) as the lighting-period changed quantity defined by normalizing a differential value between the lighting-period received light quantity received by the light receiver at one time point and the lighting-period received light quantity received by the light receiver at another time point. With employing this configuration, even if the luminance of the light source and the sensitivity of the light receiver fluctuate or change, the increase or decrease of the detection-target object can be detected correctly.

### (Configuration K)

As to any one of the configuration A to J, the detection processor uses the light-OFF time difference “ed(x, tb)” as the non-lighting-period changed quantity defined by a differential value between the non-lighting-period received light quantity received by the light receiver at one time point and the non-lighting-period received light quantity received by the light receiver at another time point. With employing this configuration, the non-lighting-period changed quantity can be acquired easily.

### (Configuration L)

As to any one of the configurations A to J, the detection processor uses the lighting-OFF period change ratio “pd(x, tb)” as the non-lighting-period changed quantity defined by normalizing a differential value between the non-lighting-period received light quantity received by the light receiver at one time point and the non-lighting-period received light quantity received by the light receiver at another time point. With employing this configuration, even if the sensitivity of the light receiver fluctuate or change, the factor of timewise change of the light quantity of ambient light can be detected correctly.

### (Configuration M)

The above described object removement control system includes the object detection apparatus of any one of the configurations A to L, and the control unit such as the wiper controller 106 to control an operation of the removing unit such as the wiper 107 capable of removing the detection-target object based on a result of a detection process by the object detection apparatus. With employing this configuration, an operation of the removing unit can be controlled correctly.

### (Configuration N)

The above described method of detecting an object includes emitting detection-use light from a light source, receiving first light having lighting-period received light quantity used for detecting a detection-target object existing within a lighting area of the detection-use light when the light source emits the detection-use light, and second light having non-lighting-period received light quantity when the light source does not emit the detection-use light, and performing a detection process to determine whether a given condition used for detecting an increase or decrease of the detection-target object within the lighting area is satisfied based on lighting-period changed quantity indicating a change of the lighting-period received light quantity over the time, and non-lighting-period changed quantity indicating a change of the non-lighting-period received light quantity over the time. By using the non-lighting-period changed quantity, it can determine whether the factor of timewise change of the light quantity of ambient light is included when the lighting-period changed quantity changes. Therefore, by performing suitable processing to the factor of timewise change of the light quantity of ambient light, the increase or decrease of the detection-target object can be detected correctly based on the lighting-period changed quantity.

### (Configuration O)

The non-transitory storage medium storing a program that, when executed by a computer of the object detection apparatus of any one of the configurations A to L, causes the computer such as the detection processor to execute a method of detecting an object including emitting detection-use light from a light source, receiving first light having lighting-period received light quantity used for detecting a detection-target object existing within a lighting area of the detection-use light when the light source emits the detection-use light, and second light having non-lighting-period received light quantity when the light source does not emit the detection-use light, and performing a detection process to determine whether a given condition used for detecting an increase or decrease of the detection-target object within the lighting area is satisfied based on lighting-period changed quantity indicating a change of the lighting-period received light quantity over the time, and non-lighting-period changed quantity indicating a change of the non-lighting-period received light quantity over the time. By using the non-lighting-period changed quantity, it can determine whether the factor of timewise change of the light quantity of ambient light is included when the lighting-period changed quantity changes. Therefore, by performing suitable processing to the factor of timewise change of the light quantity of ambient light, the increase or decrease of the detection-target object can be detected correctly based on the lighting-period changed quantity.

The program can be distributed by storing the program in a storage medium or carrier medium such as CD-ROM. Further, the program can be distributed by transmitting signals from a given transmission device via a transmission medium such as communication line or network (e.g., public phone line, specific line) and receiving the signals. When transmitting signals, a part of data of the program is transmitted in the transmission medium, which means that entire data of the program is not required to be on the transmission medium at one time. The signal for transmitting the program is a given carrier wave of data signal including the program. Further, the program can be distributed from a given transmission device by transmitting data of program continually or intermittently.

As to the above described example embodiments, the false detection and/or miss detection of a detection target caused by ambient light that enters the light receiver and also a factor other than the ambient light can be suppressed, in particular prevented.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

As described above, the present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

What is claimed is:

1. An object detection apparatus comprising:
a light source to emit detection-use light
a light receiver to receive first light having lighting-period received light quantity used for detecting a detection-target object existing within a lighting area of the detection-use light when the light source emits the detection-use light, and second light having non-lighting-period received light quantity when the light source does not emit the detection-use light; and
a detection processor to perform a detection process to determine whether a given condition used for detecting an increase or decrease of the detection-target object within the lighting area is satisfied based on lighting-period changed quantity indicating a change of the lighting-period received light quantity over the time and a non-lighting-period changed quantity indicating a change of the non-lighting-period received light quantity over the time.

2. The object detection apparatus of claim 1, wherein the given condition includes a first condition and a second condition, the first condition is used to determine whether the increase or decrease of the detection-target object is detected within the lighting area using the lighting-period changed quantity without using the non-lighting-period changed quantity, and the second condition is used to determine whether a determination result of the first condition is used as a result of the detection process by using the non-lighting-period changed quantity.

3. The object detection apparatus of claim 2, wherein the first condition includes a condition that the lighting-period changed quantity is a first threshold or more, and the second condition includes a condition that the non-lighting-period changed quantity is smaller than a second threshold.

4. The object detection apparatus of claim 1, wherein when the detection processor determines whether the given condition is satisfied, the detection processor does not use the lighting-period changed quantity when the non-lighting-period changed quantity is the second threshold or more.

5. The object detection apparatus of claim 1, wherein when the detection processor obtains results of a plurality of detection processes performed within a given condition changeable period, the detection processor changes the given condition to be used for a detection process to be performed after the given condition changeable period based on the results of the plurality of detection processes.

6. The object detection apparatus of claim 1, wherein when the detection processor obtains results of a plurality of detection processes performed within a given condition changeable period, the detection processor changes a duration of a change monitoring period for monitoring the change of the lighting-period received light quantity over the time to be used for a detection process to be performed after the given condition changeable period based on the results of the plurality of detection processes.

7. The object detection apparatus of claim 1, wherein the detection-target object is an object adhereable on an optical transparency material lighted by the detection-use light of the light source.

8. The object detection apparatus of claim 1, wherein the detection processor determines whether the detection process is to be performed depending on an operation timing of a removing unit capable of intermittently removing the detection-target object within the lighting area.

9. The object detection apparatus of claim 1, wherein the lighting-period changed quantity is defined by a differential value between the lighting-period received light quantity received by the light receiver at one time point and the lighting-period received light quantity received by the light receiver at another time point.

10. The object detection apparatus of claim 1, wherein the lighting-period changed quantity is defined by normalizing a differential value between the lighting-period received light quantity received by the light receiver at one time point and the lighting-period received light quantity received by the light receiver at another time point.

11. The object detection apparatus of claim 1, wherein the non-lighting-period changed quantity is defined by a differential value between the non-lighting-period received light quantity received by the light receiver at one time point and the non-lighting-period received light quantity received by the light receiver at another time point.

12. The object detection apparatus of claim 1, wherein the non-lighting-period changed quantity is defined by normalizing a differential value between the non-lighting-period received light quantity received by the light receiver at one time point and the non-lighting-period received light quantity received by the light receiver at another time point.

13. A object removement control system comprising:
the object detection apparatus of claim 1; and
a control unit to control an operation of a removing unit capable of removing the detection-target object based on a result of a detection process by the object detection apparatus.

14. A method of detecting an object comprising:
emitting detection-use light from a light source;
receiving first light having lighting-period received light quantity used for detecting a detection-target object existing within a lighting area of the detection-use light when the light source emits the detection-use light, and second light having non-lighting-period received light quantity when the light source does not emit the detection-use light; and
performing a detection process to determine whether a given condition used for detecting an increase or decrease of the detection-target object within the lighting area is satisfied based on lighting-period changed quantity indicating a change of the lighting-period received light quantity over the time, and non-lighting-period changed quantity indicating a change of the non-lighting-period received light quantity over the time.

15. A non-transitory storage medium storing a program that, when executed by a computer, causes the computer to execute a method of detecting an object comprising:
emitting detection-use light from a light source;
receiving first light having lighting-period received light quantity used for detecting a detection-target object existing within a lighting area of the detection-use light when the light source emits the detection-use light, and second light having non-lighting-period received light quantity when the light source does not emit the detection-use light; and
performing a detection process to determine whether a given condition used for detecting an increase or decrease of the detection-target object within the lighting area is satisfied based on lighting-period changed quantity indicating a change of the lighting-period received light quantity over the time, and non-lighting-period changed quantity indicating a change of the non-lighting-period received light quantity over the time.
